(19) United States
(12) Patent Application Publication
(10) Pub. No.: US 2018/0041578 A1
(43) Pub. Date: Feb. 8, 2018

(54) Inter-Telecommunications Edge Cloud Protocols

(71) Applicant: Futurewei Technologies, Inc., Plano, TX (US)

(72) Inventors: Young Lee, Plano, TX (US); Wei Wei, Plano, TX (US); Konstantinos Kanonakis, Dallas, TX (US)

(21) Appl. No.: 15/231,364

(22) Filed: Aug. 8, 2016

(51) Int. Cl. H04L 29/08; H04L 29/06; H04L 12/911

(52) U.S. Cl. CPC H04L 67/1097; H04L 47/70; H04L 67/16; H04L 67/42

(57) ABSTRACT

A first telecommunications edge cloud (TEC) element deployed between a client and a packet network includes a TEC hardware layer including storage resources, networking resources, and computing resources, wherein the computing resources include a plurality of processors. The networking resources are configured to transmit a first general update message to a plurality of second TEC elements within a federation, transmit a first application-specific update message to the second TEC elements within the federation, and receive a plurality of second update messages from the second TEC elements that are associated with the federation. The federation includes the second TEC elements and the first TEC element and shares resources to provide data and services to a requesting client. The storage resources are coupled to the computing resources and the networking resources and configured to store a second generic resource container and second application-specific resource container for each of the second TEC elements.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Cloud computing is a model for the delivery of hosted services, which may then be made available to users through, for example, the Internet. Cloud computing enables ubiquitous, convenient, on-demand network access to a shared pool of configurable computing resources that can be provisioned and employed with minimal management effort or service provider interaction. By employing cloud computing resources, providers may deploy and manage emulations of particular computer systems through a network, which provide convenient access to the computing resources.

### SUMMARY

One of the problems in the prior art in deploying cloud computing resources to a requesting customer is the cost and latency associated with having to access a backbone network to transmit services and content to the requesting customer. The concepts disclosed herein solve this problem by forming a federation of multiple modular and scalable telecommunications edge cloud (TEC) elements that are disposed between multiple requesting customers and the backbone network. The federation of TEC elements (“federation”) is configured to communicate and share resources with each other to find the most efficient way to provide cloud data and services to the customers.

In one embodiment, the disclosure includes a TEC element within a federation, comprising computing resources, networking resources coupled to the computing resources, and storage resources coupled to the computing resources and the networking resources. The computing resources comprise a plurality of processors, and the networking resources comprise a plurality of network input and output ports. The networking resources are configured to transmit a first general update message to a plurality of second TEC elements within the federation. The first general update message comprises a first generic resource container of the first TEC element, wherein the first generic resource container identifies a total amount of resource capacity of the first TEC element. The federation containing the second TEC elements and the first TEC element share resources to provide at least one of data and services to a requesting client. The networking resources are further configured to transmit a first application-specific update message to the second TEC elements within the federation, wherein the first application-specific update message comprises a first application-specific resource container of the first TEC element, and wherein the first application-specific resource container identifies an amount of resources reserved by the first TEC element for an application. The networking resources are further configured to receive a plurality of second resource update messages from the second TEC elements within the federation, wherein each of the second resource update messages comprise a second generic resource container and a second application-specific resource container, wherein the second generic resource container identifies a total amount of resource capacity of each of the second TEC elements, and wherein the second application-specific resource container identifies an amount of resources reserved by the each of the second TEC elements for the application. The storage resources are configured to store the second generic resource container and the second application-specific resource container for each of the second TEC elements, wherein the first TEC element and the second TEC elements are deployed between the client and a packet network. In some embodiments, the disclosure also includes wherein the networking resources are further configured to receive a federation creation request from a second TEC element, wherein the second TEC element is the master TEC element in the federation and is the only TEC element in the federation that is permitted to add new TEC elements to the federation and remove TEC elements from the federation. In some embodiments, the disclosure also includes wherein the networking resources are further configured to receive a master assignment request from the second TEC element, wherein the master assignment request is a request for the first TEC element to assume the role of the master TEC element in the federation. In some embodiments, the disclosure also includes wherein the first TEC element sends a federation creation request to a second TEC element, wherein the first TEC element is the only TEC element in the federation that is permitted to add new TEC elements to the federation and remove TEC elements from the federation. In some embodiments, the disclosure also includes wherein the first TEC element comprises an application layer, a TEC operating system (TECOS), and a hardware layer, wherein the hardware layer comprises the computing resources, the networking resources, and the storage resources, wherein the TECOS comprises an inter-TEC federation manager configured to manage communication and sharing resources with the second TEC elements of the federation, and wherein the application layer comprises an application that receives a request from the requesting client for the data or the services, wherein the networking resources further comprises at least one of a provider edge (PE) router, an optical line terminal (OLT), a broadband network gateway (BNG), wireless access point equipment, and an optical transport network (OTN) switch. In some embodiments, the disclosure also includes further comprising an application layer configured to receive a request from the requesting client for the data or the services corresponding to an application on the application layer, wherein the computing resources are configured to select one of the second TEC elements in the federation that has sufficient resource capacity to provide the data or services to the client according to at least one of the second generic resource container and the second application-specific resource container for each of the second TEC elements, and wherein the networking resources are configured to redirect the request to the selected one of the second TEC elements in the federation.

In one embodiment, the disclose includes an apparatus for providing cloud computing services to a client, comprising computing resources, networking resources coupled to the computing resources, and storage resources. The computing resources comprise a plurality of processors, and the networking resources comprise a plurality of input and output ports. The networking resources are configured to transmit a first general update message to a plurality of second TEC elements that within a federation, wherein the first general update message comprises a first generic resource container of the apparatus, wherein the first generic resource container identifies a total amount of resource capacity of the apparatus, and wherein the federation containing the second TEC elements and the apparatus share resources to provide at least one of data and services to a requesting client. The networking resources are further configured to transmit a first application-specific update message to the second TEC elements within the federation, wherein the first application-specific update message comprises a first application-specific resource container of the apparatus, and wherein the first application-specific resource container identifies an amount of resources reserved by the first TEC for an application. The networking resources are further configured to receive a plurality of second update messages from the second TEC elements within the federation, wherein each of the second update messages comprise at least one of a second generic resource container and a second application-specific resource container, wherein the second generic resource container identifies a total amount of resource capacity of each of the second TEC elements, and wherein the second application-specific resource container identifies an amount of resources reserved by the each of the second TEC elements for the application. The storage resources are configured to store the second generic resource container and the second application-specific resource container for each of the second TEC elements, wherein the first TEC element and the second TEC elements are deployed between the client and a packet network. In some embodiments, the disclosure also includes wherein the first general update message comprises an identifier of the apparatus, an identifier of the federation, and a resource container, wherein the resource container comprises at least one of a server load, a power consumption, a virtual central processing unit (vCPU) load, a hypervisor capacity, a computing hosts capacity, a number of vCPUs available for execution, a status of a hypervisor, a number of computing hosts available for execution, a number of virtual machines (VMs) that are capable of running an instance for each host, a number of VMs that are running instances for each host, and a number of VMs that are idle. In some embodiments, the disclosure also includes wherein the first application-specific update message comprises an identifier of the apparatus, an identifier of the federation, an identifier of the application, and an application-specific resource container, wherein the application specific resource container comprises at least one of a server load assigned to the application, a power consumption assigned to the application, a virtual central processing unit (vCPU) load assigned to the application, a hypervisor capacity assigned to the application, a computing hosts capacity assigned to the application, a number of vCPUs available for execution assigned to the application, a status of a hypervisor for the application, a number of computing hosts available for execution assigned to the application, a number of virtual machines (VMs) that are capable of running an instance for each host assigned to the application, a number of VMs that are running instances for each host assigned to the application, and a number of VMs that are idle assigned to the application. In some embodiments, the disclosure also includes further comprising an application layer configured to receive a request from the requesting client for the data or the services corresponding to an application on the application layer, wherein the computing resources are configured to select one of the second TEC elements in the federation that has sufficient resource capacity to provide the data or the services to the client, and wherein the networking resources are configured to transmit a redirection request to redirect the request from the client to the selected one of the second TEC elements in the federation, receive an acceptance of the redirection request from the selected one of the second TEC elements in the federation, and redirect the request from the client to the selected on of the second TEC elements in the federation. In some embodiments, the disclosure also includes further comprising comprises an application layer, a TECOS, and a hardware layer, wherein the hardware layer comprises the computing resources, the networking resources, and the storage resources, wherein the TECOS comprises an inter-TEC federation manager configured to manage communication and sharing resources with the second TEC elements of the federation, and wherein the application layer comprises an application that receives a request from the requesting client for data or a service.

In one embodiment, the disclosure includes method implemented by a first TEC element within a federation, comprising receiving, using networking resources of the first TEC element, a plurality of resource update messages from a plurality of second TEC elements within the federation, wherein the resource update message comprises at least one of a generic resource container and an application-specific resource container, wherein the generic resource container comprises information about a total amount of resources available at each of the second TEC elements, wherein the application-specific resource container comprises information about an amount of resources reserved for an application at each of the second TEC elements, wherein the federation comprises the second TEC elements and the first TEC element that share resources and provide requested data or services to a client. The method further comprises storing, in storage resources coupled to the networking resources of the first TEC element, the generic resource container and the application-specific resource container. and the method further comprises sharing the storage resources, computing resources, and the networking resources of the first TEC element with the second TEC elements in the federation according to the generic resource container and the application-specific resource container, wherein the first TEC element and the second TEC elements are deployed between the client and a packet network. In some embodiments, the disclosure also includes wherein the storage resources are further configured to store a federation policy identifying with the federation, wherein the federation policy comprises a rank of the second TEC elements in the federation according to a resource capacity of each of the second TEC elements. In some embodiments, the disclosure also includes wherein the resource update messages are received from the second TEC elements of the federation periodically according to a pre-defined schedule stored in the storage resources. In some embodiments, the disclosure also includes wherein the resource update messages only comprise the application-specific resource container, wherein the application-specific resource container only comprises information about a single resource that has exceeded a threshold indicating that the single resource is unavailable to be shared. In some embodiments, the disclosure also includes wherein the resource update message including the application-specific resource container only comprises information about the single resource. In some embodiments, the disclosure also includes wherein sharing the storage resources, computing resources, and the networking resources of the TEC element with the second TEC elements in the federation further comprises receiving a request from the client for the data or the services provided by an application on an application layer of the first TEC element, and selecting, using the computing resources, one of the second TEC elements when the storage resources indicates that the one of the second TEC elements has sufficient resources to accommodate the request from the client. In some embodiments, the disclosure also includes wherein sharing the storage resources, computing resources, and the networking resources of the TEC element with the second TEC elements in the federation further comprises transmitting, using the networking resources, a redirection request to redirect the request from the client to the selected one of the TEC elements, and sending, using the networking resources, the request from the client to the selected one of the TEC elements in response to receiving an acceptance of the redirection from the selected one of the TEC elements. In some embodiments, the disclosure also includes wherein the first TEC element is a master TEC element of the first TEC element, and wherein the first TEC element is the only TEC element in the federation permitted to request additional TEC elements to join the federation.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system comprising a packet network.

FIG. 2 is a schematic diagram of an embodiment of a system comprising a packet network and a federation of TEC elements.

FIG. 3 is a schematic diagram of an embodiment of the TEC element.

FIG. 4 is a schematic diagram of an embodiment of a hardware module within a TEC element.

FIG. 5 is a schematic diagram of an embodiment of a hardware module within a TEC element.

FIG. 6 is a schematic diagram of an embodiment of a TEC element.

FIG. 7 is a schematic flow diagram of an embodiment of using the TEC element.

FIG. 8 is a schematic diagram of an embodiment of a federation.

FIG. 9 is a schematic diagram of an embodiment of an access ring.

FIG. 10 is a message sequence diagram illustrating an embodiment of creating and deleting a federation.

FIG. 11 is a message sequence diagram illustrating an embodiment of assigning a TEC element as a master TEC element of a federation.

FIG. 12 is a schematic diagram of an embodiment of a federation including TEC elements that send resource update messages to one another.

FIG. 13 is a message sequence diagram illustrating an embodiment of a TEC element sending a generic resource update message to another TEC element in the federation.

FIG. 14 is a table representing a generic resource container included in a TEC resource update message.

FIG. 15 is a message sequence diagram illustrating an embodiment of a TEC element sending an application-specific resource update message to another TEC element in a federation.

FIG. 16 is a table representing an application-specific resource container included in a TEC resource update message.

FIG. 17 is a schematic diagram of an embodiment of a federation in which client requests are redirected from one TEC element to another.

FIG. 18 is a message sequence diagram illustrating an embodiment of a TEC element attempting to redirect a client request multiple TEC elements in a federation.

FIG. 19 is a flowchart of an embodiment of a method used by a TEC element to share resources with other TEC elements in the federation to provide data and services to clients.

FIG. 20 is a functional block diagram of a TEC element configured to share resources with other TEC elements in the federation to provide data and services to clients.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalent.

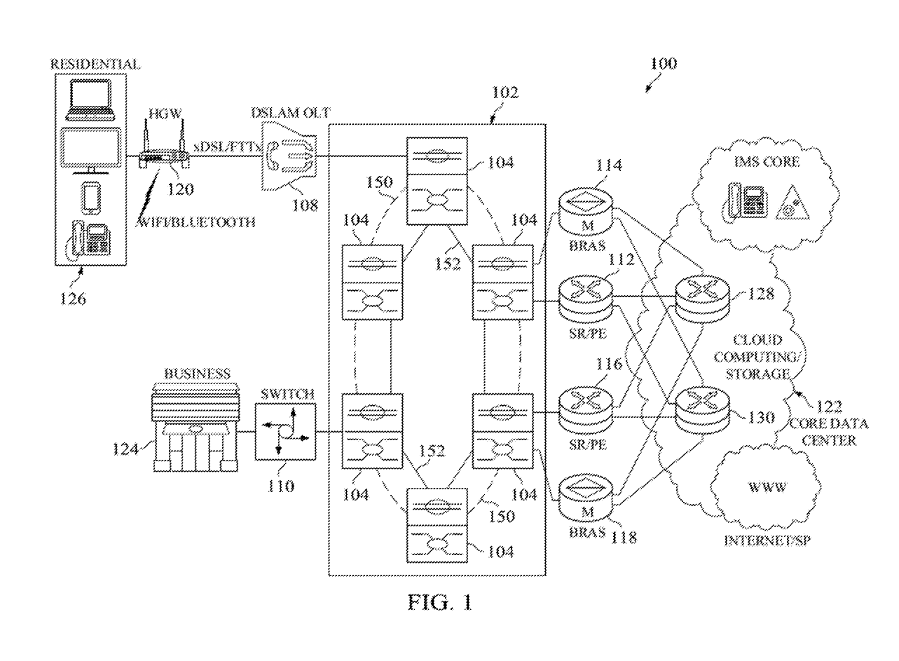

FIG. 1 is a schematic diagram of a system 100 comprising a packet network 102. System 100 is configured to support packet transport and optical transport services among network elements using the packet network 102. For example, system 100 is configured to transport data traffic for services between clients 124 and 126 and a service provider 122. Examples of services may include, but are not limited to, Internet service, virtual private network (VPN) services, value added service (VAS) services, Internet Protocol Television (IPTV) services, content delivery network (CDN) services, Internet of things (IoT) services, data analytics applications, and Internet Protocol Multimedia services. System 100 comprises packet network 102, network elements 108, 110, 112, 114, 116, 118, 120, 128, and 130, service provider 122, and clients 124 and 126. System 100 may be configured as shown or in any other suitable manner.

Packet network 102 is a network infrastructure that comprises a plurality of integrated packet network nodes 104. Packet network 102 is configured to support transporting both optical data and packet switching data. Packet network 102 is configured to implement the network configurations to configure flow paths or virtual connections between client 124, client 126, and service provider 122 via the integrated packet network nodes 104. The packet network 102 may be a backbone network which connects a cloud computing system of the service provider 122 to clients 124 and 126. The packet network 102 may also connect a cloud computing system of the service provider 122 to other systems such as external Internet, other cloud computing systems, data centers, and any other entity that requires access to the service provider 122.

Integrated packet network nodes 104 are reconfigurable hybrid switches configured for packet switching and optical switching. In an embodiment, integrated packet network nodes 104 comprise a packet switch, an optical data unit (ODU) cross-connect, and a reconfigurable optical add-drop multiplex (ROADM). The integrated packet network nodes 104 are coupled to each other and to other network elements using virtual links 150 and physical links 152. For example, virtual links 150 may be logical paths between integrated packet network nodes 104 and physical links 152 may be optical fibers that form an optical wavelength division multiplexing (WDM) network topology. The integrated packet network nodes 104 may be coupled to each other using any suitable virtual links 150 or physical links 152 as would be appreciated by one of ordinary skill in the art upon viewing this disclosure. The integrated packet network nodes 104 may consider the network elements 108-120 as dummy terminals (DTs) that represent service and/or data traffic origination points and destination points.

Network elements 108-120, 128, and 130 may include, but are not limited to, clients, servers, broadband remote access servers (BRAS), switches, routers, service router/provider edge (SR/PE) routers, digital subscriber line access multiplexer (DSLAM) optical line terminal (OTL), gateways, home gateways (HGWs), service providers, PE network nodes, customers edge (CE) network nodes, an Internet Protocol (IP) router, and an IP multimedia subsystem (IMS) core.

Clients 124 and 126 may be user devices in residential and business environments. For example, client 126 is in a residential environment and is configured to communicate data with the packet network 102 via network elements 120 and 108 and client 124 is in a business environment and is configured to communicate data with the packet network 102 via network element 110.

Examples of service provider 122 may include, but are not limited to, an Internet service provider, an IPTV service provider, an IMS core, a private network, an IoT service provider, and a CDN. The service provider 122 may include a cloud computing system. The cloud computing system, cloud computing, or cloud services may refer to a group of servers, storage elements, computers, laptops, cell phones, and/or any other types of network devices connected together by an Internet protocol (IP) network in order to share network resources stored at one or more data centers of the service provider 122. With a cloud computing solution, computing capabilities or storage resources are provisioned and made available over the network 102. Such computing capabilities may be elastically provisioned and released, in some cases automatically, to scale rapidly outward and inward based on demand.

In one embodiment, the service provider 122 may be a core data center that pools computing or storage resources to serve multiple clients 124 and 126 that request services from the service provider 122. For example, the service provider 122 uses a multi-tenant model where fine-grained resources may be dynamically assigned to a client specified implementation and reassigned to other implementations according to consumer demand. In one embodiment, the service provider 122 may automatically control and optimize resource use by leveraging a metering capability at some level of abstraction appropriate to the type of resource (e.g., storage, processing, bandwidth, and active user accounts). A cloud computing solution provides requested resources without requiring clients to establish a computing infrastructure to service the clients 124 and 126. Clients 124 and 126 may provision the resources in a specified implementation by providing various specifications and artifacts defining a requested solution. The service provider 122 receives the specifications and artifacts from clients 124 and 126 regarding a particular cloud-based deployment and provides the specified resources for the particular cloud-based solution via the network 102. Clients 124 and 126 have little control or knowledge over the exact location of the provided resources, but may be able to specify location at a higher level of abstraction (e.g., country, state, or data center).

Cloud computing resources may be provided according to one or more various models. Such models include Infrastructure as a Service (IaaS), Platform as a Service (PaaS), and Software as a Service (SaaS). In IaaS, computer infrastructure is delivered as a service. In such a case, the computing equipment is generally owned and operated by the service provider 122. In the PaaS model, software tools and underlying equipment used by developers to develop software solutions may be provided as a service and hosted by the service provider. SaaS includes a service provider licensing software as a service on demand. The service provider 122 may host the software, or may deploy the software to a client for a given period of time. The service provider 122 may provide requested cloud-based services to the requesting clients 124 and 126 via either the IaaS, PaaS, or SaaS model.

Regardless of the employed model, one of the biggest challenges in deploying such cloud computing resources is the cost and latency associated with accessing the network 102 to receive requested data from the service provider 122 and transmit the requested data to the requesting client 124 or 126. For example, client 124 in a residential environment requests data, such as streaming media content, from the service provider 122. The service provider 122 that has the requested content is geographically distant from the requesting client 124 or 126 or a central office (CO)/remote office that serves the requesting client 124 or 126. Therefore, the service provider 122 must pay a cost for leasing a portion of the infrastructure in the network 102 to a telecommunication (telecom) service provider to provide the requested content to the client 124. In the same way, the telecom service provider bears the cost of providing networking resources to the service provider 122 to transmit the requested content to the CO or the client 124 or 126. The client 124 or 126 further suffers latency and Quality of Service (QoS) issues when the requested content is stored at a data center that is geographically far away from the CO or the client 124 or 126. Therefore, cloud deployment where the service provider 122 is located a great distance from the CO and the clients 124 and 126 takes a considerable amount of time, costs a considerable amount of money, is difficult to debug, and makes transporting data through a complex networking infrastructure laborious.

In addition, cloud computing resources are usually stored in the data center of the service provider 122 and provided to COs via the network 102 on an as needed basis. The data center includes a complex system of servers and storage elements to store and process the cloud computing resources. For example, the data center includes a large and complex system of storage and processing equipment that is interconnected by leaf and spine switches that cannot easily be transported or modified. Networking hardware at the CO, such as a router or a switch, is configured to route the resources to the appropriate client 124 or 126. Therefore, the CO usually only includes the networking hardware necessary to route data to the clients 124 and 126. Therefore, in a traditional cloud computing environment, the CO or edge points of presence (POPs) lacks the ability to provide cloud computing services to clients 124 and 126 because of the large-scale, complex nature of the data center equipment used to provide cloud computing services to clients 124 and 126.

Disclosed herein are systems, methods, and apparatuses that provide multiple scalable and modular TEC elements that are disposed between the client, such as clients 124 and 126, and a network, such as network 102, such that the service provider 122 is able to provide requested resources to the client in a cost effective manner. The TEC elements include the same cloud computing resources that the service provider 122 includes, but on a smaller scale. As such, the TEC elements are modular and scalable and can be disposed at a location closer to the client. For example, a TEC element is disposed at a local CO/remote office that is accessible by the client without having to access the network elements 108-120, 128, and 130. The TEC elements may be grouped together based on geographic proximity into a federation such that TEC elements in the federation share resources to provide data and services to the clients.

Traditional telecom COs and edge POPs may be converted into edge data centers for common service delivery platforms using some of the embodiments disclosed herein. A compact integrated cloud environment in remote branches and COs may be valuable to telecom service providers because compact cloud environments will help improve service experiences (e.g., low latency, high throughput) to end-customers with low cost and also help improve cloud operation efficiency to service providers. Telecom service providers may transform into cloud-centric infrastructures using the embodiments of the TEC element disclosed herein.

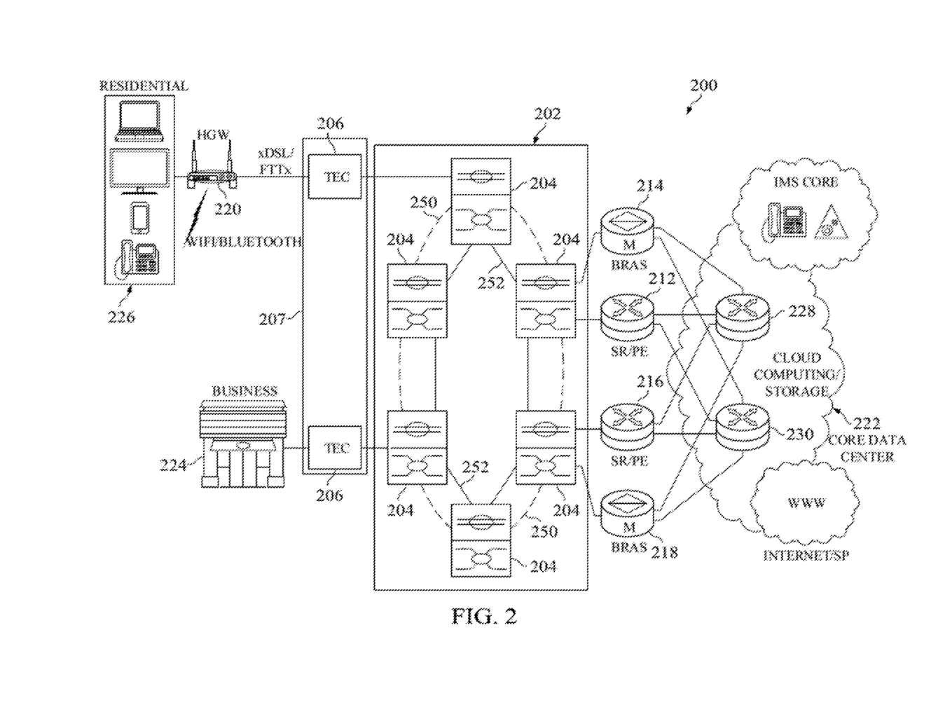

FIG. 2 is a schematic diagram of an embodiment of a system 200 comprising a packet network 202 and a federation 207 of TEC elements 206. System 200 is a distributed cloud network which is similar to system 100, except that system 200 includes one or more TEC elements 206 disposed in between the packet network 202 and the clients 224 and 226 such that the clients 224 and 226 receive data and services directly from the TEC element 206. The TEC elements 206 may be grouped together based on geographic proximity to form a federation 207. The TEC elements 206 may communicate and share resources with other TEC elements 206 in the federation 207 to provide requested data and services to clients 224 and 226. System 200 is configured to support packet transport and optical transport services among the clients 224 and 226, a TEC element 206, and the service provider 222 using the packet network 202 when necessary. System 200 comprises a packet network 202, network elements 212, 214, 216, 218, 220, 228, and 230, service provider 222, TEC element 206, and clients 224 and 226, each of which are configured to operate in fashions similar to those described in system 100. The network 202 comprises a plurality of network nodes 204 that are configured to implement the network configurations to configure flow paths between the TEC element 206 and the service provider 222 via the network nodes 204. As shown in FIG. 2, the TEC elements 206, and thus the federation 207, are disposed in between the clients 224 and 226 and the packet network 202. System 200 may be configured as shown or in any other suitable manner.

System 200 is configured to transport data traffic for services between clients 224 and 226 and the TEC element 206. System 200 may also be configured to transport data traffic for services between the TEC element 206 and the service provider 222. Examples of services may include, but are not limited to, Internet service, VPN services, VAS services, IPTV services, CDN services, IoT services, data analytics applications, and Internet Protocol Multimedia services.

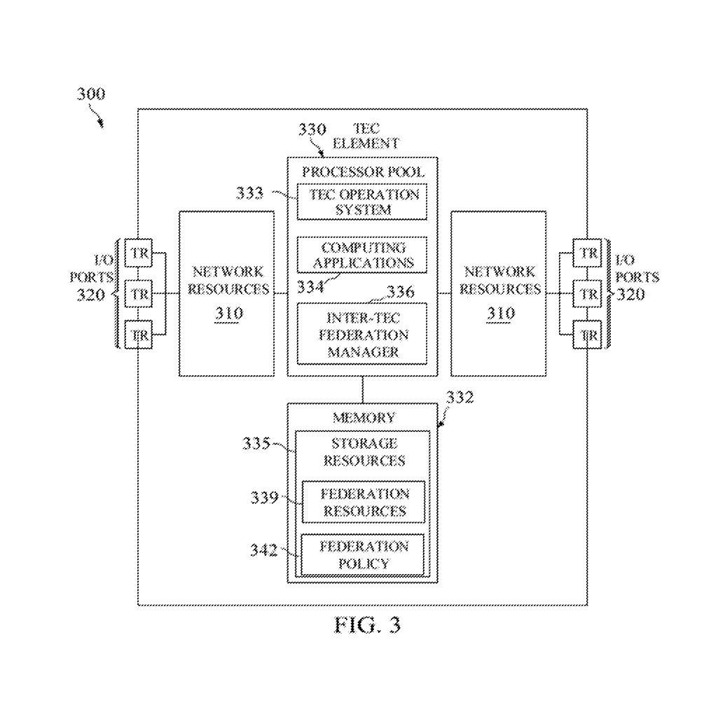

In some embodiments, the TEC element 206 is a device that is configured to operate in a manner similar to the service provider 222, except that the TEC element 206 is a miniaturized version of a data center that also includes networking input/output functionalities, as further described below in FIG. 3. The TEC element 206 may be implemented using hardware, firmware, and/or software installed to run on hardware. The TEC element 206 is coupled to network elements 212, 214, 216, and 218 using any suitable virtual links 250, physical links 252, or optical fiber links. As shown in FIG. 2, the TEC element 206 is disposed in a location between the clients 224 and 226 and the network 202. The TEC element 206 may periodically synchronize cloud data from the service provider 222 via the network 202. TEC element 206 stores the cloud data locally in a memory or/and a disk so that the TEC element 206 may transmit the cloud data to a requesting client without having to access the network 202 to receive the data from the service provider 222.

In one embodiment, the TEC element 206 may be configured to receive data, such as content, from the service provider 222 via the network 202 and store the data in a cache of the TEC element 206. For example, the TEC element 206 receives specified data for a particular cloud-based application via the network 202 and stores the data into the cache. A client 226 in a residential environment may transmit a request to the TEC element 206 for a particular cloud-based deployment associated with the particular cloud-based application that has now been stored in the cache. The TEC element 206 is configured to search the cache of the TEC element 206 for the requested cloud-based application and provide the data directly to the client 226. In this way, the client 226 receives the requested content from the TEC element 206 faster than if the client 224 were to receive the content from the service provider 222 via the network 202.

The federation 207 is a group of TEC elements 206 that are geographically located proximate to one another. The federation 207 may include one master TEC element 206 and a plurality of other TEC elements 206. The master TEC element 206 may be the only TEC element within the federation 207 that has permission to add other TEC elements 206 to the federation 207. The TEC elements 206 within the federation 207 are permitted to and configured to share resources with one another to provide data and services to the clients 224 and 226. For example, a user may request to access a cloud application from a first TEC element 206. However, the first TEC element 206 may be unable to provide the requested data to the client. For example, the first TEC element 206 may not have the sufficient hardware, software, or firmware resources to instantiate a virtual machine to run the cloud application and provide requested services to the client. In such a case, the first TEC element 206 may identify whether another TEC element 206 in the federation has sufficient resources to provide the requested services to the client. In one embodiment, the first TEC element 206 receives periodic updates from each of the TEC elements 206 in the federation 207 indicating an amount of available resources for each of the TEC elements 206. The data regarding the available resources for each of the TEC elements 206 in the federation 207 may be stored locally at each of the TEC elements 206 within the federation 207. In this way, the first TEC element 206 knows which of the TEC elements 206 in the federation 207 has sufficient resources to provide the requested services to the client. The first TEC element 206 may then select one of the TEC elements 206 in the federation 207 that has sufficient resources and send a redirection request to that TEC element 206 to process the client request. Therefore, creating federations 207 of TEC elements 206 allows for cooperating TEC elements 206 to communicate with each other to provide data and services to clients without having to unnecessarily generate traffic on the packet network 202.

The TEC element 206 may be disposed at a CO disposed in between the network 202 and the clients 224 and 226. In one embodiment, the TEC element 206 is a compact and intelligent edge data center working as a common service delivery platform. The TEC element 206 is a highly flexible and extensible element in terms of supporting existing telecom services by leveraging network function virtualization (NFV) techniques, such as carrier Ethernet services, voice over Internet protocol (VoIP) services, cloud-based video streaming services, IoT services, smart home services, smart city services, etc. The TEC methods and systems disclosed herein will help telecom service providers and/or content service providers improve user experiences while reducing the cost of telecom services. The TEC methods and systems disclosed herein also help telecom service providers and/or content service providers conduct rapid service innovations and rapid service deployments to clients 224 and 226. In this way, the TEC element 206 performs faster and provides higher quality data than a traditional cloud computing system, located at a distant service provider 222.

FIG. 3 is a schematic diagram of an embodiment of a TEC element 300, which is similar to TEC element 206 of FIG. 2. The TEC element 300 is a modular telecom device which integrates networking resources, computing resources, storage resources, operation system, and various cloud applications into one compact box or chassis. The TEC element 300 is configured to communicate with other TEC elements in a federation to share resources when necessary. The TEC element 300 may be a modified network element, a modified network node, or any other logically/physically centralized networking, computing, and storage device that are configured to store and execute cloud computing resources locally, share resources, and transmit data to a client, such as clients 224 and 226. The TEC element 300 may be configured to implement and/or support the telecom edge cloud system mechanisms and schemes described herein. The TEC element 300 may be implemented in a single box/chassis or the functionality of the TEC element 300 may be implemented in a plurality of interconnected boxes/chassis. The TEC element 300 may be any device including a combination of devices (e.g., a modem, a switch, router, bridge, server, client, controller, memory, disks, cache, etc.) that stores cloud computing resources and transports or assists with transporting the cloud applications or data through a network, such as the network 202, system, and/or domain.

At least some of the features/methods described in the disclosure are implemented in a networking/computing/storage apparatus such as the TEC element 300. For instance, the features/methods in the disclosure may be implemented using hardware, firmware, and/or software installed to run on hardware. The TEC element 300 is any device that has cloud computing resources, storage resources, and networking resources that transports packets through a network, e.g., a switch, router, bridge, server, a client, etc. As shown in FIG. 3, the TEC element 300 comprises network resources 310, which may be transmitters, receivers, switches, routers, switching fabric or combinations thereof. In some embodiments, the network resources 310 may comprise PE router, an OLT, a BNG, wireless access point equipment, and an OTN switch. The network resources 310 are coupled to a plurality of input/output (I/O) ports 320 for transmitting and/or receiving packets or frames from other nodes.

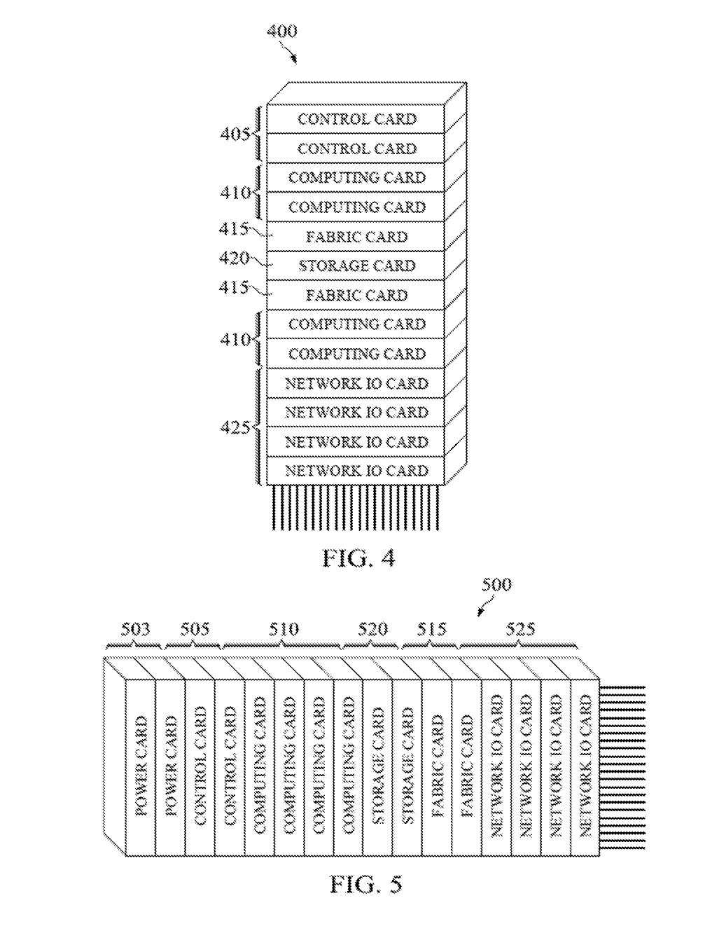

A processor pool 330 is a logical central processing unit (CPU) in the TEC element 300 that is coupled to the network resources 310 and executes computing applications such as virtual network functions (VNFs) to manage various types of resource allocations to various types of clients 224 and 226. The processor pool 330 may comprise one or more multi-core processors and/or memory devices 332, which may function as data stores, buffers, etc. In one embodiment, the processor pool 330 is implemented by one or more computing cards and control cards, as further described in FIGS. 4 and 5. In one embodiment, the processor pool 330 may be implemented as generic servers, virtual machines (VMs), containers or may be part of one or more application specific integrated circuits (ASICs) and/or digital signal processors (DSPs).

The processor pool 330 comprises a TECOS 333, an inter-TEC federation manager 336, and computing applications 334, and may implement message sequence diagrams 1000, 1100, 1300, 1500, and 1800, method 1900, as discussed more fully below, and/or any other flowcharts, schemes, and methods discussed herein. In one embodiment, the TECOS 333 may control and manage the networking, computing, and storage functions of the TEC element 300 and may be implemented by one or more control cards, as further described with reference to FIGS. 4 and 5. In one embodiment, the inter-TEC federation manager 336, which manages communication between the TEC element 300 and other TEC elements in the federation, may be implemented by one or more computing cards, as further described with reference to FIGS. 4 and 5. The processor pool 330 also comprises computing applications 334, which may perform or execute cloud computing operations requested by clients 224 or 226. In one embodiment, the computing applications 334 may be implemented by one or more computing cards, as further described with references to FIGS. 4 and 5. As such, the inclusion of the TECOS 333, the inter-TEC federation manager 336, the computing applications 334, and associated methods and systems provide improvements to the functionality of the TEC element 300. Further, the TECOS 333, the inter-TEC federation manager 336, and the computing applications 334 may effect a transformation of a particular article (e.g., the network) to a different state. In an alternative embodiment, the TECOS 333, the inter-TEC federation manager 336, and the computing applications 334 may be implemented as instructions stored in the memory device 332, which may be executed by the processor pool 330. The processor pool 330 may have any other means to implement FIGS. 4 and 5.

The memory device 332 may comprise storage resources 335. The storage resources 335 may comprise federation resources 339 that include information related to the resources of other TEC elements of a federation and a federation policy 342 that includes information related to a configuration of the federation. The storage resources 335 may include a cache for temporarily storing content, e.g., a random-access memory (RAM). Additionally, the storage resources 335 may comprise a long-term storage for storing content relatively longer, for example, a read-only memory (ROM). For instance, the cache and the long-term storage may include dynamic RAMs (DRAMs), solid-state drives (SSDs), hard disks, or combinations thereof.

FIG. 4 is a schematic diagram of an embodiment of a hardware module 400 within a TEC element. The hardware module 400 may be similar to the hardware of the TEC element 300 of FIG. 3. The hardware module 400 comprises one or more control cards 405, one or more computing cards 410, one or more fabric cards 415, one or more storage cards 420, and one or more network I/O cards 425. The hardware module 400 shows a horizontal arrangement of the various cards, or hardware components. As should be appreciated, the control cards 405, computing cards 410, fabric cards 415, storage cards 420, or network I/O cards 425 may be implemented as one or more hardware boards or blades. The hardware module 400 is scalable in that the TEC operator can build or modify the hardware module 400 to include more or less of any one of the hardware cards as necessary to provide the functionality desired. For example, a TEC operator may modify a hardware module 400 located at the CO to include more storage cards 420 when a region supported by the CO needs to store more cloud applications or data locally due to a higher demand.

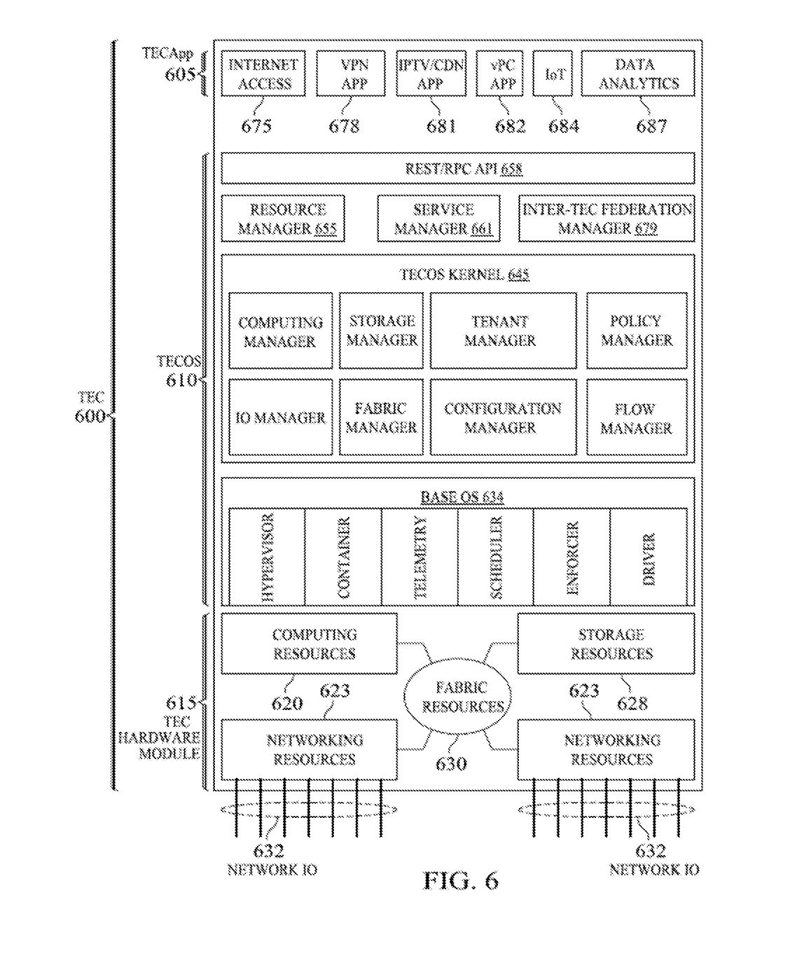

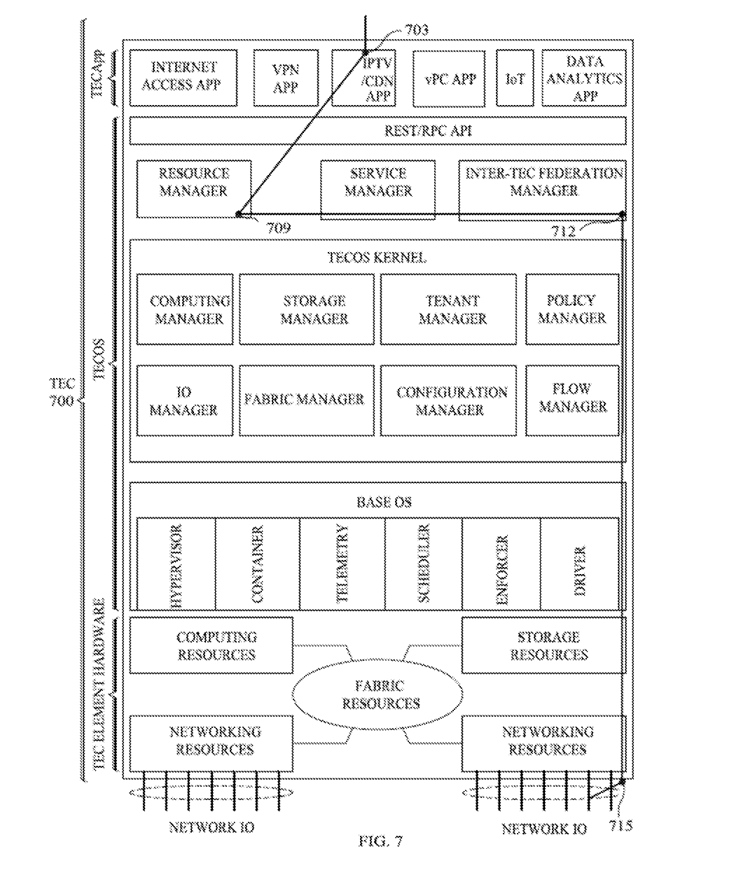

In some embodiments, the control cards 405 comprise one or more processors and memory devices, and may be configured to execute a TECOS, as will be further described below in FIG. 6. In one embodiment, the processors in the control cards 405 may be similar to the processor pool 330 of FIG. 3. In one embodiment, the memory devices in the control cards 405 may be similar to the memory devices 332 of FIG. 3. In one embodiment, each of the control cards 405 is configured to execute one instance of the TECOS. In some embodiments, the computing cards 410 comprise one or more processors and memory devices 332, and may be configured to implement the functions of the computing resources, such as VMs and containers for cloud applications. In some embodiments, one or more of the computing cards 410 is configured to execute the inter-TEC federation manager, such as the inter-TEC federation manager 336. In some embodiments, the storage cards 420 comprise one or more memory devices and may be configured to implement the functions of the storage resources, such as storage resources 335. The storage cards 420 may comprise more memory devices than the control cards 405 and the computing cards 410. The network I/O cards 425 may comprise transmitters, receivers, switches, routers, switch fabric or combinations thereof, and may be configured to implement the functions of the networking resources, such as the networking resources 310. In one embodiment, the network I/O cards 425 comprise a provider edge router, a wireless access point, an optical line terminal, and/or a broadband network gateway. In one embodiment, the fabric cards 415 may be an Ethernet switch, which is configured to interconnect all related hardware resources to provide physical connections as needed.

As shown in FIG. 4, the hardware module 400 includes two control cards 405, two computing cards 410, one fabric card 415, four network I/O cards 425, and one storage card 420. The hardware module 400 may be about 19 to 23 inches wide. The hardware module 400 is a height suitable to securely enclose each of the component cards. The hardware module 400 may include a cooling system for ventilation. The hardware module 400 may comprise at least 96-128 CPU cores. The storage card 420 may be configured to store at least 32 Terabyte (TB) of data. The network I/O cards 425 may be configured to transmit and receive data at a rate of approximately 1.92 TB per second (s). The embodiment of the hardware module 400 shown in FIG. 4 serves, for example, up to 10,000 customers. The flow classification/programmable capability of the network I/O resources can be up to one million flows (i.e., 100 flows support for each end-customers in the case of 10,000 customers, one flow may be a TV channel).

The hardware module 400 may further include a power supply port configured to receive a power cord, for example, that provides power to the hardware module 400. In some embodiments, the hardware module 400 is configured to monitor the surrounding environment, record accessing of the storage card 420, monitor operations performed at and by the hardware module 400, provide alerts to a TEC operator upon certain events, be remotely controlled by a device controlled by a TEC operator located distant from the hardware module 400, and control a timing of operations performed by the hardware module 400. In one embodiment, the hardware module 400 comprises a dust ingress protector that protects dust from entering into the hardware module 400.

FIG. 5 is a schematic diagram of an embodiment of a hardware module 500 within a TEC element. The hardware module 500 is similar to hardware module 400, except that the hardware module 500 further includes a power card 503, a different number of the one or more control cards 505, one or more computing cards 510, one or more fabric cards 515, one or more storage cards 520, and one or more network I/O cards 525, and each of the component cards are arranged in a vertical manner instead of a horizontal manner. The power card 503 may be hardware configured to provide power and/or a fan to the hardware module 500. The hardware modules 400 and 500 show an example of how the TEC elements disclosed herein are designed to be modular and flexible in design to accommodate an environment where the TEC element will be located and a demand of the resources needed by the clients requesting data from the TEC element.

FIG. 6 is a schematic diagram of an embodiment of a TEC element 600. In one embodiment, TEC element 600 is similar to the TEC element 206, 300, 400, and 500 of FIGS. 2-5, respectively. The TEC element 600 conducts the networking, storage, and computing related functions for the benefit of clients 224 and 226 of FIG. 2. The TEC element 600 comprises a TEC application layer 605, a TECOS 610, and a TEC hardware module 615. In one embodiment, the TECOS 610 is similar to the TECOS 333 of FIG. 3. The TEC application layer 605 shows example services or applications that clients, such as clients 224 and 226, may request from a cloud computing environment. The TECOS 610 may be a software suite that executes to integrate the networking, computing, and storage capabilities of the TEC element 600 to provide the abstracted services to clients using the TEC hardware module 615. The TEC hardware module 615 comprises the hardware components that provide the services to the clients. The TEC hardware module 615 may be structured similar to the TEC elements 400 and 500 of FIGS. 4-5.

The TEC application layer 605 is a layer describing various services or applications that a client may request from a TEC element 600. The services include, but are not limited to, an internet access application 675, a VPN application 678, an IPTV/CDN application 681, a virtual private cloud (vPC) application 682, an IoT application 684, and a data analytics application 687. The internet access application 675 may be an application that receives and processes a request from a client or a network operator for access to the internet. The VPN application 678 may be an application that receives and processes a request from a client or a network operator to establish a VPN within a private network (e.g., private connections between two or more sites over service provider networks). The IPTV/CDN application 681 may be an application that receives and processes a request from a client or a network operator for content from an IMS core. The vPC application 682 may be an application that is accessed by a TEC element administrator to allocate computing or storage resources to customers. The IoT application 684 may be an application that receives and processes a request from a smart item for content or services provided by a services provider, such as service provider 222. The data analytics application 687 may be an application that receives and processes a request from a client or a network operator for data stored at a data center in a cloud computing system. The internet access application 675, VPN application 678, IPTV/CDN application 681, IoT application 684, and data analytics application 687 may each be configured to transmit the requests to access cloud computing resources to the TECOS 610 for further processing. In some embodiments, the TEC applications can be developed by a TEC operator and external developers to provide a rich TEC ecosystem.

The TEC application layer 605 may interface with the TECOS 610 by means of application programming interfaces (APIs) based on a representational state transfer (REST) or remote procedure call (RPC)/APIs 658. The TECOS 610 is configured to allocate and deallocate the hardware resources of the TEC hardware module 615 to different clients dynamically and adaptively according to applications requirements. The TECOS 610 may comprise a base operating system (OS) 634, a TECOS kernel 645, a resource manager 655, the REST/RPC API 658, a service manager 661, and an inter-TEC federation manager 679. In one embodiment, the inter-TEC federation manager may be similar to the inter-TEC federation manager 336 of FIG. 3. The components of the TECOS 610 communicate with each to manage control over the TEC element 600 and all of the components in the TEC hardware module 615.

The REST/RPC API 658 is configured to provide an API collection for applications to request and access the resources and program the network I/O in a high-level and automatic manner. The TEC application layer 605 interfaces with the TECOS 610 by means of REST/RPC APIs 658 to facilitate TEC application development both by the TEC operator and external developers, thus resulting in a rich TEC ecosystem. Some of the basic functions that the TECOS 610 components should support through the REST/RPC API 658 include, but are not limited to, the following calls: retrieve resources (GET), reserve resources (POST), release resources (DELETE), update resources (PUT/PATCH), retrieve services (GET), create/install services (POST), remove services (DELETE), and update services (PUT/PATCH). Moreover, the various applications may listen and react to events or alarms triggered by the TECOS 610 through the REST/RPC API 658.

The components of the TECOS kernel 645 communicate with the resource manager 655, REST/RPC API 658, and the service manager 661 to abstract the hardware components in the TEC hardware module 615 that are utilized to provide a requested service to a client. The resource manager 655 is configured to manage various types of logical resources (e.g., VMs, containers, virtual networks, and virtual disks) in an abstract and cohesive way. For example, the resource manager 655 allocates, reserves, instantiates, activates, deactivates, and deallocates various types of resources for clients and notifies the service manager 661 of the operations performed on the resources. In one embodiment, the resource manager 655 maintains the relationship between various logical resources in a graph data structure.

The service manager 661 is configured to provide service orchestration mechanisms to discompose the TEC application requests into various service provisioning units (e.g., VM provisioning and network connectivity provisioning) and map them to the corresponding physical resource units to satisfy a service level agreement (SLA). An SLA is a contract between a service provider and a client that defines a level of service expected by the service provider and/or the client. In one embodiment, the resource manager 655 and the service manager 661 communicate with the TECOS kernel 645 by means of direct/native method/function calls to provide maximum efficiency given the large amount of API calls utilized between the components of the TECOS 610.

The inter-TEC federation manager 679 is configured to receive requests from an application at the TEC application layer 605. The inter-TEC federation manager 679 is configured to compute a generic resource capacity for the TEC element 600. In an embodiment, the inter-TEC federation manager 679 computes a capacity for a specific resource in the TEC element 600 by subtracting a used amount of the resource from the total amount of the resource available at the TEC element. In an embodiment, the generic resource capacity may be associated with at least one of a server load, a free memory space, a power consumption, a virtual CPU, a hypervisor, a compute host, a number of vCPUs, a number of hypervisors, or a number of compute hosts. The inter-TEC federation manager 679 is also configured to compute an application-specific resource capacity for each of the applications on the TEC application layer 605. The inter-TEC federation manager 679 may compute a capacity for an application-specific resource in the TEC element by subtracting a used amount of the resource that is reserved for the application from a total amount of the resource that is reserved for the application.

In an embodiment, the inter-TEC federation manager 679 may be configured to generate resource capacity messages including information related to the generic resource capacity and application-specific resource capacity for certain resources. The resource capacity message may include the resource capacity of the entire TEC element 600 and the application-specific resource capacity. In an embodiment, the inter-TEC federation manager 679 instructs the networking resources 623 and the network I/O 632 to transmit the resource capacity messages to other TEC elements in the federation that the TEC element 600 is a part of. The TEC element 600 also receives similar resource capacity messages from the other TEC elements in the federation via the networking resources 623 and the network I/O 632, and stores the resource capacity data of the other TEC elements in the storage resources 628. In an embodiment, the TEC element 600 stores the resource capacity of other TEC elements in the federation in the federation resources 339 of the storage resources 628.

In an embodiment, the inter-TEC federation manager 679 may access a federation policy, such as the federation policy 342, that is stored in the storage resources 628. The federation policy may be pre-configured onto the TEC element 600 by a TEC operator. The federation policy may include thresholds related to each of the resources of the TEC element. In an embodiment, the inter-TEC federation manager 679 is configured to periodically compare a resource of the TEC element 600 to a threshold in the federation policy to determine whether the resource exceeds the threshold. The TEC element 600 may be configured to transmit on-demand resource update messages to the other TEC elements in the federation when the resource of the TEC element 600 exceeds the threshold. In such a case, the resource update message only includes information about the resource that exceeds the threshold.

In an embodiment, when the TEC application layer 605 receives a request from a client, the inter-TEC federation manager 679 is configured to determine whether the request can be processed at the TEC element 600 based on the resource capacity information. For example, the TEC element 600 may not be capable of processing a request because the TEC element 600 may not have enough memory in the storage resources 628. In such a case, the inter-TEC federation manager 679 is configured to identify another TEC element of the federation that has sufficient resources to process the request. The inter-TEC federation manager 679 is configured to instruct the networking resources 623 and the network I/O 632 to redirect the request to the other TEC element in the federation if the other TEC element accepts the redirection request.

The TECOS kernel 645 may comprise a computing manager, a storage manager, a tenant manager, a policy manager, an input/output (I/O) manager, a fabric manager, a configuration manager, and a flow manager. The computing manager may be configured to provide the life-cycle management services for VMs and containers. For example, the computing manager manages the creation/deletion, activation/deactivation, loading, running, and stopping an image or program that is running. The storage manager may be configured to offer low-level storage resources functionalities such as virtual disk allocation and content automatic replication. The tenant manager is configured to manage the tenants in an isolated manner for the virtual vPC application. For example, the tenant manager is configured to partition the memory of the TEC element 600 based on at least one of a client, a telecommunication service provider, a content service provider, and a location of the TEC element. The policy manager may be configured to manage the high-level rules, preferences, constraints, objectives, and intents for various resources and services. The service manager 661 and resource manager 655 may access and configure the policy manager when needed. The I/O manager is configured to manage all networking I/O port resources in terms of data rate, data format, data protocol, and switching or cross-connect capability. The resource manager may access the I/O manager for the allocation/deallocation of networking resources. The fabric manager is configured to provide internal communications between various hardware cards/boards/blades. In one embodiment, the fabric manager comprises a plurality of physical or virtual links configured to facilitate the transmission of data between the hardware resources within the TEC element and between other TEC elements 600. The configuration manager may communicate with the resource manager 655 to configure parameters, such as an Internet Protocol (IP) addresses, for hardware and software components. The flow manager is configured to program the network I/O system with flow rules such as a match/actions set. A flow rule such as match/actions concept defines how a traffic flow is processed inside the TEC element. The match is usually based on meta-data, such as source subnet/IP address, destination subnet/IP address, Transmission Control Protocol (TCP) port, and IP payload type. The actions may be dropped, forwarded to another I/O port, go to the VNF for further processing, and delegated to the TECOS.

The base operating system 634 may be an operating system, such as Microsoft Windows®, Linux®, Unix®, or a brand-new light-weight real-time computer operation system, configured to integrate with the TECOS kernel 645, resource manager 655, REST/RPC API 658, and service manager 661 to manage control over the TEC hardware module 605 and to provide requested services to clients. In some embodiments, the base operating system 634 may be Debian-based Linux or RTLinux. The base operating system 634 comprises a hypervisor, container, telemetry, scheduler, enforcer, and driver. The hypervisor is configured to slice the computing and storage resources into VMs. For example, the hypervisor is a kernel-based virtual machine (KVM)/quick emulator (QEMU) hypervisor. The container is a native way to virtualize the computing resources for different applications such as VNFs and virtual content delivery networks (vCDN). For example, the container is a docker. The telemetry is configured to monitor events/alarms/meters and to collect statics data from the data planes including the hardware and software, such as the VNFs. The scheduler is configured to decide the best way to allocate the available resources to various service units. For example, the scheduler selects the best network I/O port based on a given policy setting when there are many available network I/O ports. The enforcer is configured to maintain the SLA for each type of service unit based on given polices such as a bandwidth guarantee for a traffic flow. The driver is configured to work closely with the hardware and software components to fulfill the actual hardware operations such as task executions and multi-table flow rules programming.

The TEC hardware module 615 comprises computing resources 620, networking resources 623, storage resources 628, fabric resources 630, and network I/O 632. The computing resources 620 comprises multiple CPUs, memories, and/or more multi-core processors and/or memory devices, which may function as data stores, buffers, etc. The computing resources 620 may be implemented as a general processor or may be part of one or more application specific integrated circuits (ASICs) and/or digital signal processors (DSPs). The computing resources 620 are configured to provide sliced computing environments such as VMs or containers through the TECOS 610 to control applications and virtual network functions. In one embodiment, the computing resources 620 are coupled to the storage resources 628 and the networking resources 623 through the fabric resources 630.

The storage resources 628 may be a hard disk or disk arrays. In one embodiment, the storage resources 628 may be a cache configured to temporarily store data received from core data centers in the service provider networks. The networking resources 623 may be coupled to the storage resources 628 so that the networking resources 623 may transmit the data to the storage resources 628 for storage.

The networking resources 623 may be coupled to the network input/outputs (I/O) 632. The networking resources 623 may include, but are not limited to, switches, routers, service router/provider edge (SR/PE) routers, wireless access point, digital subscriber line access multiplexer (DSLAM) optical line terminal (OTL), gateways, home gateways (HGWs), service providers, PE network nodes, customers edge (CE) network nodes, an Internet Protocol (IP) router, optical transport transponders, and an IP multimedia subsystem (IMS) core. The networking resources 623 are configured to receive client packets or cloud service requests, which are processed by the computing resources 620 or stored by the storage resources 628, and if needed it will be switched to other networking I/Os 632 for forwarding. The networking resources 623 are also configured to transmit requested data to a client using the network I/Os 632. The network I/Os 632 may include, but are not limited to, transmitters and receivers (Tx/Rx), network processors (NP), and/or traffic management hardware. The network I/Os 632 are configured to transmit/switch and/or receive packets/frames from other nodes, such as network nodes 204, and/or network elements, such as network elements 208 and 210.

The fabric resources 630 may be physical or virtual links configured to couple the computing resources 620, the networking resources 623, and the storage resources 628 together. The fabric resources 630 may be configured to interconnect all related hardware resources to provide physical connections. The fabric resources 630 may be analogous to the backplane/switching fabric cards/boards/blades in legacy switch/router equipment.

FIG. 7 is a schematic flow diagram of an embodiment of using a TEC element 700 to provide internet access service to a requesting client. In one embodiment, the TEC element 700 is similar to the TEC elements 206, 300, 400, 500, and 600 of FIGS. 2-6. In one embodiment, the clients may be similar to clients 224 and 226. At point 703, an IPTV/CDN application at a TEC application layer receives a request from a client for streaming media content, such as video content, that may be stored at the TEC element 700, or at another TEC element in the same federation as the TEC element 700. In an embodiment, the IPTV/CDN application is similar to the IPTV/CDN application 681 of FIG. 6, and the TEC application layer is similar to the TEC application 605 of FIG. 6. At point 709, the resource manager receives the request from the IPTV/CDN application. In an embodiment, the resource manager may be similar to the resource manager 655 of FIG. 6. The resource manager may determine whether there are sufficient resources to accommodate the request or new resources need to be created or reserved to accommodate the request. For example, if the TEC element 700 does not have enough power to accommodate the request, the resource manager determines that there are insufficient resources at the TEC element 700. As another example, if the TEC element 700 does not have the requested streaming media content stored in a cache of the TEC element 700, the resource manager determines that there are insufficient resources at the TEC element 700. At point 712, the inter-TEC federation manager may receive the request and attempt to redirect the request to another TEC element in the same federation as the TEC element 700. In an embodiment, the inter-TEC federation manager may be similar to the inter-TEC federation managers 336 and 679. The inter-TEC federation manager may be configured to identify another TEC element in a federation that has sufficient resources to accommodate the request. In an embodiment, the inter-TEC federation manager may select an optimal one of the TEC elements in the federation that has sufficient resources to accommodate the request. The inter-TEC federation manager may then instruct the networking resources and the networking I/O to transmit a redirection request to the selected TEC element. At point 715, the networking resources and the networking I/O receives the instructions to transmit the redirection request and performs the transmission of the redirection request to the selected TEC element in the federation. In an embodiment, the networking resources may be similar to the networking resources 623 of FIG. 6, and the network I/O may be similar to the network I/O 632 of FIG. 6. In an embodiment, the network I/O and the networking resources receive a reply back from the selected one of the TEC elements in the federation indicating whether or not the selected TEC element accepted redirection request. The inter-TEC federation manager may transmit the request to the selected TEC element if the selected TEC element accepted the redirection request.

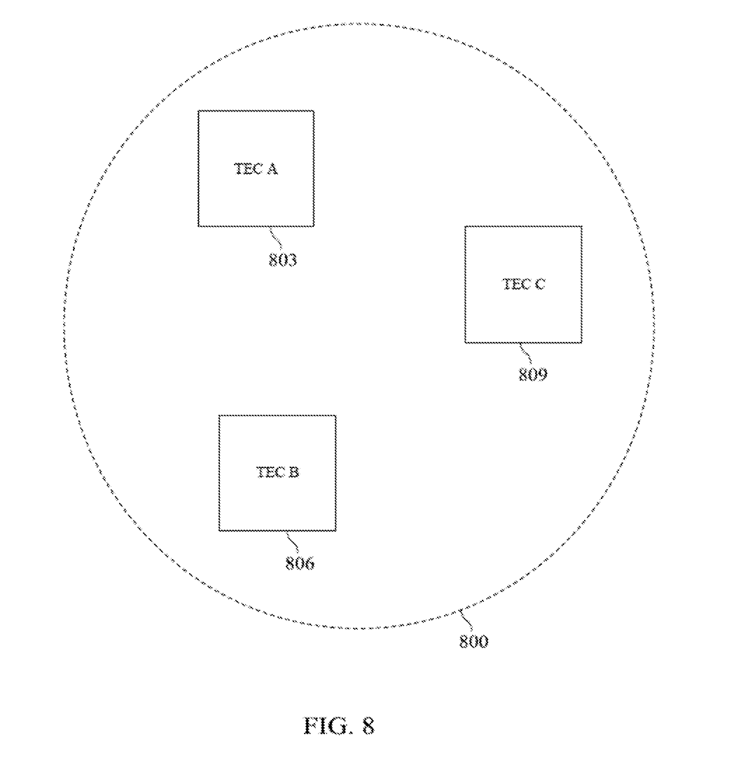

FIG. 8 is a schematic diagram of an embodiment of a federation 800. The federation 800 may be similar to the federation 207 of FIG. 2. The federation 800 comprises TEC element A 803, TEC element B 806, and TEC element C 809. Each of the TEC element A 803, TEC element B 806, and TEC element C 809 in federation 800 may be similar to the TEC elements 206, 300, 400, 500, and 600 of FIGS. 2-6. As should be appreciated, the federation 800 may comprise any number of TEC elements that are configured to communicate with each other to provide data and services to clients.

In one embodiment, the TEC elements in a federation 800 may be geographically proximate to one another. For example, TEC element A 803 may serve clients from a first geographical region, TEC element B 806 may serve clients from a second geographical region, and TEC element C may serve clients from a third geographical region. The first, second, and third geographical regions may be geographically proximate to one another. TEC element A 803, TEC element B 806, and TEC element C 809 may each be deployed between the clients (e.g., clients 224 and 226 of FIG. 2) and the packet network (e.g., packet network 202 of FIG. 2). Each of TEC element A 803, TEC element B 806, and TEC element C 809 may provide data and services directly to the clients without having to pass through the packet network to receive the data and/services from the service provider (e.g., service provider 222 of FIG. 2). The formation of the federation 800 allows for different TEC elements to share resources with one another when the TEC element that locally serves the client does not have sufficient resources to meet client demands. The federation 800 shares resources amongst each of TEC element A 803, TEC element B 806, and TEC element C 809 to better serve customers when there is a high client demand.

In an embodiment, one of the TEC elements may be specified by a TEC operator, for example, as a master TEC element of the federation 800. Suppose TEC element A 803 is pre-configured to be the master TEC element of the federation 800. For example, the federation policy 342 of FIG. 3 may indicate whether a TEC element is pre-configured to be a master TEC element. A master TEC element is the only TEC element in federation 800 that is permitted and/or configured to request another geographically proximate TEC element to join the federation 800 and share resources with the TEC elements of the federation.

In an embodiment, one of the TEC elements may be assigned as the default master TEC element the federation 800 is established. For example, TEC element A 803 may send a request to TEC element B 806 asking TEC element B to join in the creation of the federation 800. In this case, TEC element A 803 is assigned as the default master TEC element of the federation 800 because TEC element A 803 initiated creation of the federation 800. The TEC element A 803, operating as the master TEC element, is the only TEC element permitted to add new TEC elements to the federation 800. TEC element B 806 may not be permitted to request new TEC elements to join the federation 800.

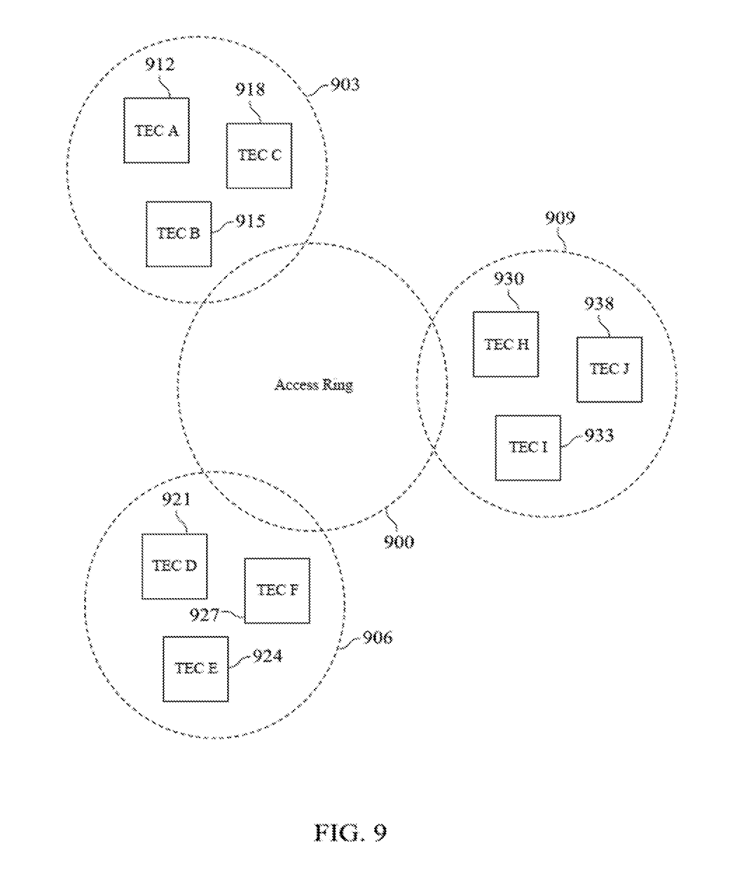

FIG. 9 is a schematic diagram of an embodiment of an access ring 900. The access ring 900 may comprise one or more federations 903, 906, and 909. In one embodiment, the federations 903, 906, and 909 may be geographically proximate to one another. Each of the federations 903, 906, and 909 may comprise one or more TEC elements. As shown in FIG. 9, federation 903 comprises TEC element A 912, TEC element B 915, TEC element C 918, federation 906 comprises TEC element D 921, TEC element E 924, and TEC element F 927, and federation 909 comprises TEC element H 930, TEC element I 933, and TEC element J 938. In an embodiment, the TEC elements shown in FIG. 9 may be similar to TEC elements 206, 300, 400, 500, and 600 of FIGS. 2-6. In an embodiment, each of the federations 903, 906, and 909 may be deployed between the clients (e.g., clients 224 and 226) and the packet network (e.g., packet network 202 of FIG. 2).

The TEC elements in each of the federations of the access ring 900 are permitted and configured to communicate with each other. In an embodiment, the TEC elements 912, 915, 918, 921, 924, 927, 930, 933, and 938 send each other periodic updates including information about total resources, used resources, and/or available resources. The access ring 900 allows for a larger quantity of TEC elements to communicate with each other to share resources and thus, provide data and services to a client in an even more efficient manner.

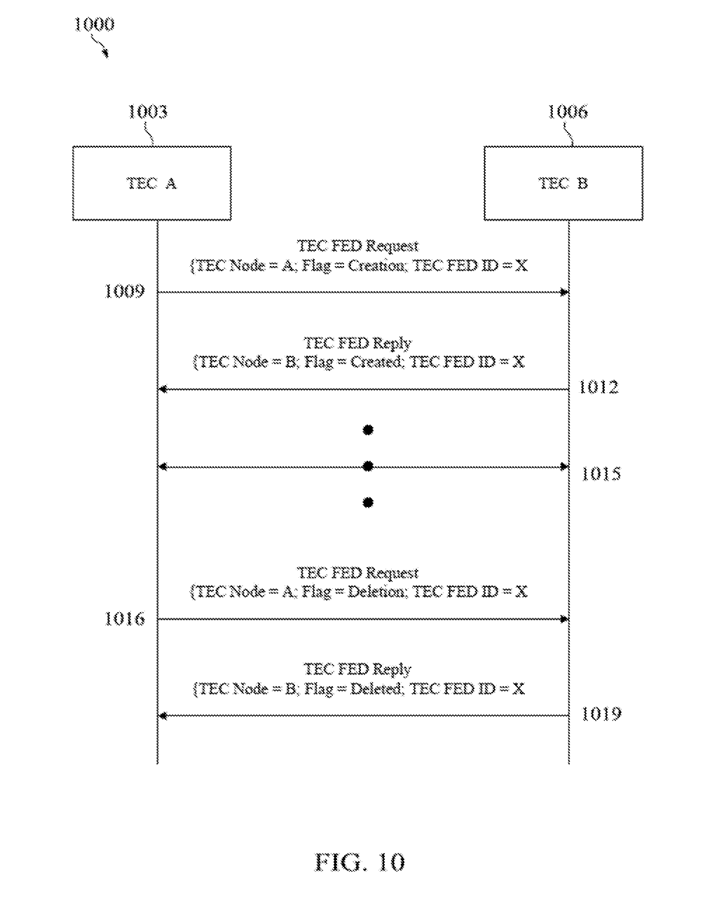

FIG. 10 is a message sequence diagram 1000 illustrating an embodiment of creating and deleting a federation. In an embodiment, the federation is similar to the federation 207, 800, 903, 906, and 909 of FIGS. 2, 8, and 9. The diagram 1000 illustrates messages exchanged by TEC element A 1003 and TEC element B 1006 during the creation and deletion of the federation depicted in FIG. 10. In such cases, the TEC elements are similar to TEC elements 206, 300, 400, 500, and 600 of FIGS. 2-6.

At step 1009, TEC element A 1003 sends a federation creation request to TEC element B 1006. For example, the inter-TEC federation manager 679 of TEC element A 1003 instructs the networking resources 623 and network I/O 632 of FIG. 6 to send the federation creation request to TEC element B 1006. In an embodiment, the federation creation request may include an identifier of the TEC element A 1003 sending the federation creation request, a flag indicating that the TEC element A 1003 is requesting the creating of a federation, and an identifier of the federation. At step 1012, the TEC element B 1006 may send a federation creation reply back to the TEC element A 1003. For example, the inter-TEC federation manager 679 of TEC element B 1006 instructs the networking resources 623 and network I/O 632 of FIG. 6 to send the federation creation reply to TEC element A 1003. In an embodiment, the federation creation reply may include an identifier of the TEC element B 1006 sending the creation federation reply, a flag indicating that the TEC element B 1006 accepts the invitation to join and create the federation, and the identifier of the federation. In an embodiment, the TEC element 1003 A may be set by default as the master TEC for the federation. At step 1015, TEC element A 1003 and TEC element B 1006 may actively communicate with each other and share resources with one another to provide data and services to clients without having to access a service provider that is deployed at a much farther distance than the TEC elements. For example, TEC element A 1003 and TEC element B 1006 communicates with each other using the components of the TEC hardware module 615 of FIG. 6.

At step 1016, the TEC element A 1003 may send a federation deletion request to the TEC element B 1006. For example, the inter-TEC federation manager 679 of TEC element A 1003 instructs the networking resources 623 and network I/O 632 of FIG. 6 to send the federation deletion request to TEC element B 1006. In an embodiment, the federation deletion request may include an identifier of the TEC element A 1003 sending the federation deletion request, a flag indicating that the TEC element A 1003 is requesting the deletion of the federation, and an identifier of the federation. At step 1019, the TEC element B 1006 may send a federation deletion reply back to the TEC element A 1003. For example, the inter-TEC federation manager 679 of TEC element B 1006 instructs the networking resources 623 and network I/O 632 of FIG. 6 to send the federation deletion reply to TEC element A 1003. In an embodiment, the federation deletion reply may include an identifier of the TEC element B 1006 sending the federation deletion reply, a flag indicating that the TEC element B 1006 disassociates from the federation and deletes the federation, and the identifier of the federation.

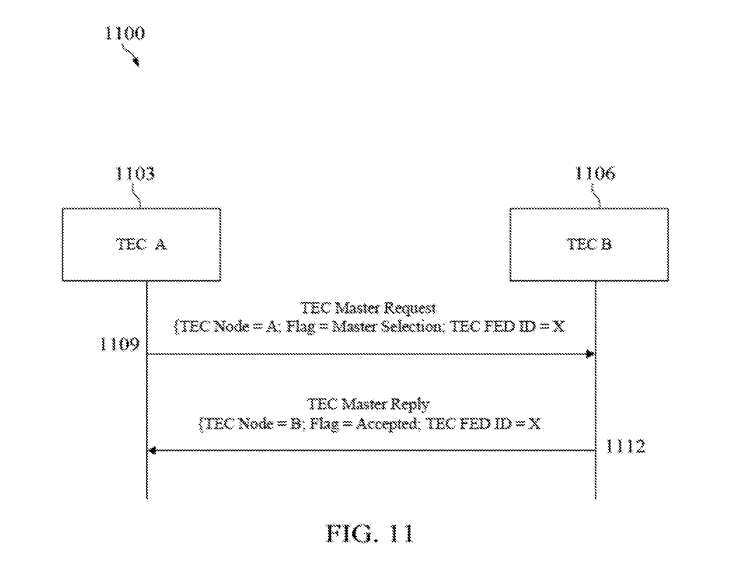

FIG. 11 is a message sequence diagram 1100 illustrating an embodiment of assigning a TEC element as a master TEC element of a federation. In an embodiment, the federation is similar to the federation 207, 800, 903, 903, and 909 of FIGS. 2, 8, and 9. In such cases, the TEC elements are similar to TEC elements 206, 300, 400, 500, and 600 of FIGS. 2-6. In one embodiment, the TEC element that first requests another TEC element to join in creating a federation becomes the master TEC element by default. For example, the TEC element A 1003 is the master TEC element of the federation described in FIG. 10 by default because the TEC element A 1003 is the TEC element in the federation that sends a request to TEC element B 1006 to create the federation. The diagram 1100 illustrates messages exchanged by TEC element A 1103 and TEC element B 1106 when the TEC element A 1103 is requesting the TEC element B 1106 to be the new master of the federation.

Suppose the TEC element A 1103 is the master TEC element of the federation by default because the TEC element A 1103 first sent a request to TEC element B 1106 to create the federation. In some embodiments, the master TEC element of a federation may request another TEC element in the federation to assume the role of master. For example, the master TEC element may not have sufficient resources to continue as the master of the federation. In such cases, the master TEC element sends a request to another TEC element in the federation to assume the role as master of the federation, as shown in diagram 1100.

At step 1109, the TEC element A 1103 sends a TEC master request to TEC element B 1106. For example, the inter-TEC federation manager 679 of TEC element A 1103 instructs the networking resources 623 and network I/O 632 of FIG. 6 to send the TEC master request to TEC element B 1106. In one embodiment, the TEC master request may include an identifier of the TEC element A 1103, a flag indicating that the TEC element A 1103 is requesting that TEC element B 1106 take on the role as master of the federation, and an identifier of the federation. At step 1112, the TEC element B 1106 may send a TEC master reply to the TEC element A 1103. For example, the inter-TEC federation manager 679 of TEC element B 1106 instructs the networking resources 623 and network I/O 632 of FIG. 6 to send the TEC master reply to TEC element A 1103. In one embodiment, the TEC master reply may include an identifier of the TEC element B 1106, a flag indicating that the TEC element B 1106 accepts the request to be the master of the federation, and the identifier of the federation. In one embodiment, TEC element B 1106 is the only TEC element in the federation that is permitted to request new TEC elements to be a part of the federation after the TEC element B 1106 sends the TEC master reply.

In an embodiment, a master TEC element may request another TEC element to be the master TEC element in the federation when a resource overload occurs at the master TEC element. A resource overload occurs when the master TEC element no longer has sufficient hardware and/or software resources to accommodate requests from clients and manage the addition of new TEC elements in the federation. In this case, when the master TEC element crashes due to resource overload and is unable to assign a new master TEC element before crashing, the federation relies on a policy that has been pre-configured by a federation or TEC operator. In an embodiment, the policy may be defined in the federation policy 342 of FIG. 3. In an embodiment, each TEC element within a certain geographical region may be pre-configured with the policy that instructs which TEC element is to assume the role of the master TEC element. For example, the policy may include a ranking of TEC elements in which the higher ranked TEC elements are automatically set to be master TEC element of a federation before the lower ranked TEC elements. The ranking of TEC elements may be based on the generic resource capacity of the TEC elements. For example, a TEC element with the highest total storage space may be ranked the highest in the ranking of TEC elements. In an embodiment, when a default TEC element in a federation adds another TEC element to the federation, the default TEC element may adjust the ranking to place the new TEC element in the ranking and transmit the ranking to the new TEC element. In this way, each of the TEC elements in the federation know the ranking of the TEC elements in case the master TEC element unexpectedly crashes.

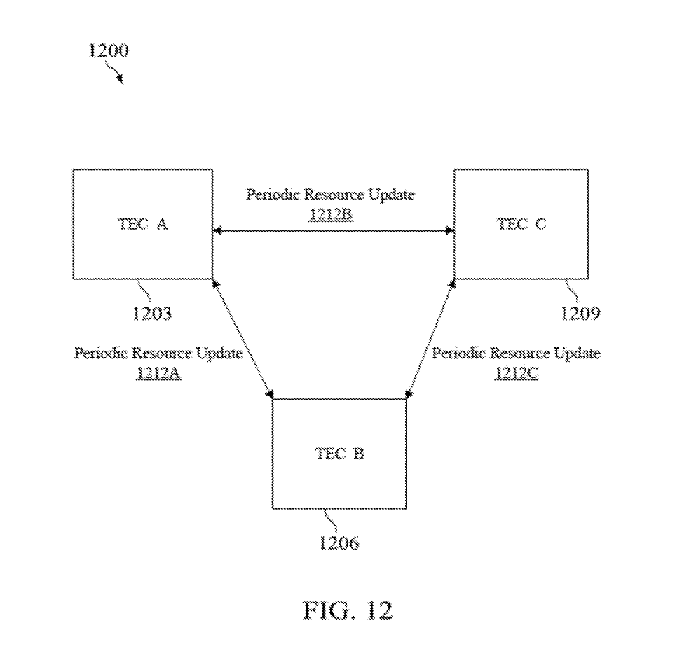

FIG. 12 is a schematic diagram of an embodiment of a federation 1200 including TEC elements that send periodic resource update messages 1212A-1212C to one another. The federation 1200 may be similar to the federation 207 and 800 of FIGS. 2 and 8. The federation 1200 comprises TEC element A 1203, TEC element B 1206, and TEC element C 1209. Each of TEC element A 1203, TEC element B 1206, and TEC element C 1209 in federation 1200 may be similar to the TEC elements 206, 300, 400, 500, and 600 of FIGS. 2-6.

In an embodiment, each of TEC element A 1203, TEC element B 1206, and TEC element C 1209 are configured to periodically send resource update messages 1212A-1212C to each other. The resource update messages may comprise data regarding hardware and software capacity for the TEC element sending the resource update message 1212A-1212C. The TEC element receiving the resource update message 1212A-1212C may store the data about the resource capacity for each TEC element in a memory of the receiving TEC element. In an embodiment, the data about resource capacity is stored in the federation resources 339 of the storage resources 335 of FIG. 3.

In an embodiment, the periodic resource update messages 1212A-1212C may include two types of resource update messages. A first type of resource update message is a generic resource update message that includes a generic resource container as further described with reference to FIG. 14. A second type of resource update message is an application-specific update message that includes an application-specific resource container as further described with reference to FIG. 16.

In an embodiment, each type of resource update message may be sent together periodically according to a pre-determined schedule set by a TEC operator that controls the federation. In an embodiment, the pre-determined schedule is included in the federation policy 342 of FIG. 3. For example, TEC element A 1203 sends TEC element B 1206 a resource update message 1212A including both the generic resource update message and the application-specific update message at the same time in one message. The TEC element B 1206 may receive this message and store both the generic resource container and the application-specific resource container locally at the TEC element B 1206. In this way, TEC element B 1206 has an updated database with information regarding a resource capacity for each of the TEC elements in the same federation as TEC element B 1206.

In an embodiment, each type of resource update message may be sent at different times according to two separate pre-determined schedules, one for the generic resource update messages and one for the application-specific resource update messages. For example, the TEC element A 1203 may send a generic resource update message to TEC element B 1206 at a first time according to a pre-determined schedule for sending generic resource update messages. The TEC element A 1203 may also send an application-specific resource update message to TEC element B 1206 at a second time according to a pre-determined for sending application-specific resource update messages.

In an embodiment, both types of resource update messages may be sent on demand when requested by another TEC element in the federation. For example, TEC element B 1206 may request an update from TEC element A 1203 when TEC element B 1206 determines that the resource capacity information for TEC element A 1203 stored in a memory of TEC element B 1206 is outdated. TEC element A 1203 may then send a reply to TEC element B 1206 with updated resource capacity information. In an embodiment, TEC element B 1206 may also send a request for application-specific resource capacity information to TEC element A 1203. TEC element A 1203 may then send a reply to TEC element B 1203 with updated application-specific resource information. Therefore, the TEC elements within a federation may be configured to communicate resource updates with each other periodically and/or on-demand.

In an embodiment, a generic resource update message and/or an application-specific resource update message can be sent when a threshold for one of the resources has been exceeded. In an embodiment, the federation policy 342 may include information regarding thresholds for each type of resource in a TEC element and/or thresholds for each type of resource that is specifically reserved for an application or application type. The TEC element A 1203 may send a generic resource update message and/or an application-specific resource update message when a threshold has been exceeded. In an embodiment, the generic resource update message and/or an application-specific resource update message may include information about the resource whose threshold has been exceeded.

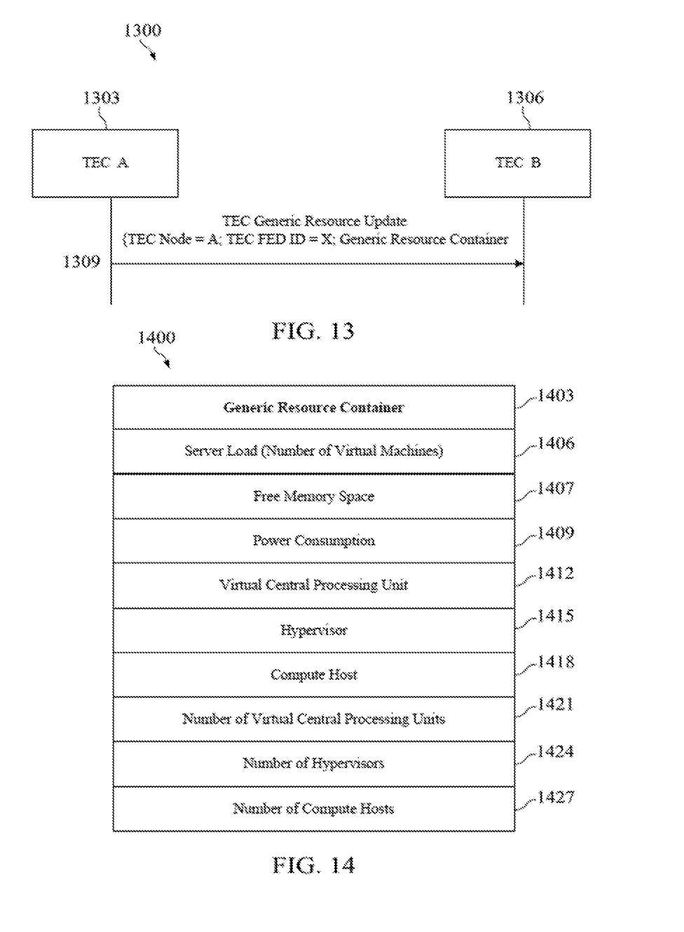

FIG. 13 is a message sequence diagram 1300 illustrating an embodiment of a TEC element A 1303 sending a generic resource update message to a TEC element B 1306. Both TEC element A 1303 and TEC element B 1306 are part of the same federation. In an embodiment, the federation is similar to the federation 1200 of FIG. 12. The diagram 1300 illustrates messages exchanged by TEC element A 1303 and TEC element B 1306 when TEC element A 1303 sends a generic resource update message to TEC element B 1306, as depicted in FIG. 13. In such cases, the TEC elements are similar to TEC elements 206, 300, 400, 500, and 600 of FIGS. 2-6. At step 1309, TEC element A 1303 sends a TEC generic resource update message to TEC element B 1306. For example, the inter-TEC federation manager 679 of TEC element A 1303 instructs the networking resources 623 and network I/O 632 of FIG. 6 to send the TEC generic resource update message to TEC element B 1006. In an embodiment, the TEC generic resource update message includes an identifier of the TEC element A 1303, an identifier of the federation, and a generic resource container, which is further described in FIG. 14. The TEC element B 1306 may then store the generic resource container locally at a memory of the TEC element B 1306. For example, the TEC element B 1306 stores the generic resource container in federation resources 339 of FIG. 3.

FIG. 14 is a table 1400 representing a generic resource container 1403 included in a TEC resource update message or a generic resource update message. In an embodiment, the generic resource container 1403 may be similar to the generic resource container in the TEC resource update described in FIG. 13. As shown in FIG. 14, the generic resource container 1403 includes at least one of a server load 1406, a free memory space 1407, a power consumption 1409, a vCPU 1412, a hypervisor 1415, a compute host 1418, a number of vCPUs 1421, a number of hypervisors 1424, and a number of compute hosts 1427. As should be appreciated, the generic resource container 1403 may include any other information that is related to a hardware or software resource capacity of a TEC element.

The number of VMs that a TEC element is capable of hosting is limited. In one embodiment, the server load 1406 describes a total number of VMs that the TEC element is capable of hosting, a number of VMs that are currently being hosted by the TEC element, and/or or a number of VMs that may still be hosted by the TEC element. The memory space available in a TEC element is limited according to a size or total storage space of the memory device (e.g., memory device 332 of FIG. 3) of the TEC element. The free memory space 1407 describes a total memory of the TEC element, the currently unavailable amount of memory, and/or the currently available amount of memory. The battery power of the TEC element is also limited. The power consumption 1409 describes a total battery power of the TEC element, an amount of battery power consumed, and/or an amount of battery power remaining.

A TEC element may include a pre-defined number of vCPUs, hypervisors, compute hosts that are each programmed to operate at a maximum capacity to produce a maximum throughput value. The vCPU 1412 describes a portion or share of a physical CPU that is assigned to a VM. The number of vCPUs 1421 describes a total amount of vCPUs of the TEC element, a number of used vCPUs on the TEC element, and/or a number of available vCPUs of the TEC element. The hypervisor 1415 describes a program that hosts and manages VMs and assigns the resources of a physical system to a specific VM. A status of the hypervisor (up or down) provides an idea of TEC's health on VM operation. The compute host 1418 hosts VMs on which instances may be created by the hypervisor. A number of VMs running instances out of a maximum number of VMs for a host, a number of VMS that are idle at a host, and/or a number of VMs that are capable of running an instance at a host may be used in determining resource capacity. The number of compute hosts 1427 describes a total amount of compute hosts of the TEC element, a number of used compute hosts of the TEC element, and/or a number of available compute hosts of the TEC element.

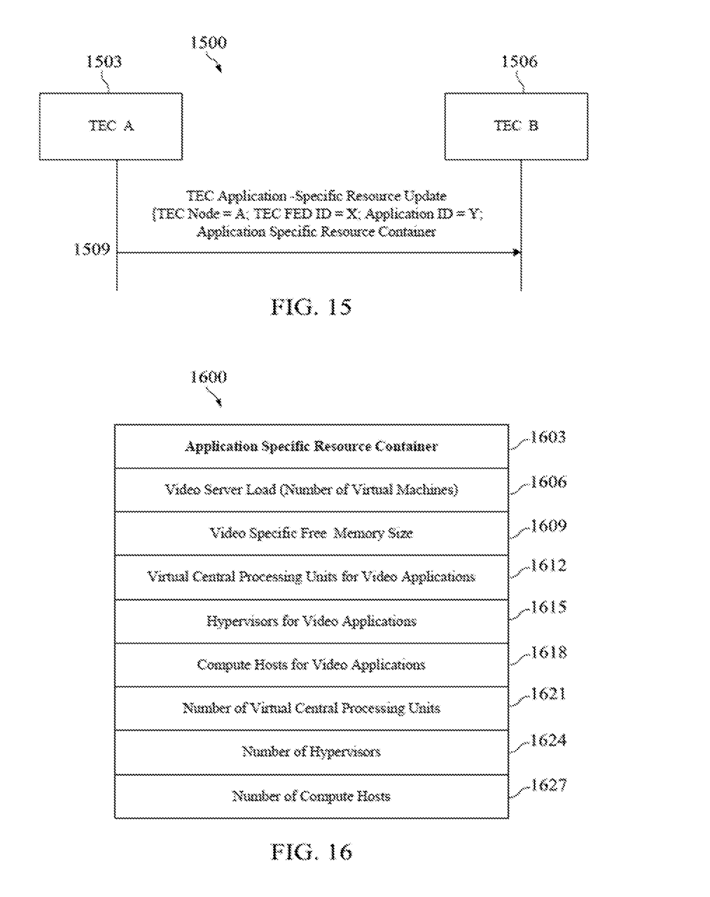

FIG. 15 is a message sequence diagram 1500 illustrating an embodiment of a TEC element A 1503 sending an application-specific resource update message to TEC element B 1506. Both TEC element A 1503 and TEC element B 1506 are part of the same federation. In an embodiment, the federation is similar to the federation 1200 of FIG. 12. The diagram 1500 illustrates messages exchanged by TEC element A 1503 and TEC element B 1506 when TEC element A 1503 sends an application-specific resource update message to TEC element B 1306, as depicted in FIG. 15. In such cases, the TEC elements are similar to TEC elements 206, 300, 400, 500, and 600 of FIGS. 2-6.

At step 1509, TEC element A 1503 sends a TEC application-specific resource update message to TEC element B 1506. For example, the inter-TEC federation manager 679 of TEC element A 1503 instructs the networking resources 623 and network I/O 632 of FIG. 6 to send the TEC application-specific resource update message to TEC element B 1006. In an embodiment, the TEC application-specific resource update message includes an identifier of the TEC element A 1503, an identifier of the federation, an identifier of an application, and an application-specific generic resource container, which is further described in FIG. 16. The TEC element B 1506 may then store the application-specific resource container locally at a memory of the TEC element B 1506. In an embodiment, TEC element B 1506 stores the application-specific resource container in the federation resources 339 of FIG. 3. The application identifier is used to identify the application that is associated with the resource capacity information described in the application-specific resource container. For example, suppose the application identifier is an identifier of an application that retrieves and sends streaming media videos for a client. The application-specific resource container includes information that is specific to the resources that are reserved for the application or the type of applications that retrieve and send the streaming media videos.

In an embodiment, TEC element A 1503 may store a policy including pre-defined threshold values associated with various resources that may be allocated to an application or type of application. For example, federation policy 342 of FIG. 3 stores a threshold value associated with storage space reserved for an application. TEC element A 1503 may transmit the application-specific resource update message to the other TEC elements in the federation when the storage space reserved for the application meets or exceeds the threshold. In this situation, the application-specific resource update message may include only the resources that exceed the thresholds. In one embodiment, the application-specific resource update messages may only be sent when a threshold has been exceeded instead of being sent periodically.

FIG. 16 is a table 1600 representing an application-specific resource container 1603 included in a TEC resource update message or a TEC application-specific resource update message. The table 1600 represents the resources that are specifically reserved by a TEC element for an application related to streaming videos. In an embodiment, the application-specific resource container 1603 may be similar to the application-specific resource container in the TEC resource update described in FIG. 15. As shown in FIG. 16, the application-specific resource container 1603 includes at least one of a video server load 1606, a video specific free memory size 1609, vCPUs for video applications 1612, hypervisors for video applications 1615, compute hosts for video applications 1618, a number of vCPUs 1621, a number of hypervisors 1624, and a number of compute hosts 1627. As should be appreciated, the application-specific resource container 1603 may include any other information that is related to a hardware or software resource capacity of a TEC element that is specifically reserved for a certain type of application or a group of applications. In an embodiment, the application-specific resource container can be programmed as a plug-in to specify the list of specific resource information pertaining to the specific application such the TEC elements can exchange information and optimize the sharing of resources as needed.

The number of VMs that an application can request to be hosted by a TEC element is limited. In one embodiment, the server load 1606 describes a total number of VMs that the TEC element is capable of hosting for the application, a number of VMs that are currently being hosted by the TEC element for the application, and/or or a number of VMs that may still be hosted by the TEC element for the application. The memory space available for a specific application to reserve in a TEC element is limited according to a size or total storage space of the memory device (e.g., memory device 332 of FIG. 3) of the TEC element. The free memory space 1607 describes a total memory of the TEC element for the application, the currently unavailable amount of memory for the application, and/or the currently available amount of memory for the application. The battery power that the application is permitted to use on the TEC element is also limited. The power consumption 1409 describes a total battery power of the TEC element reserved for the application, an amount of battery power consumed by the application, and/or an amount of battery power left that is permitted to be consumed by the application.

An application may only be permitted to use pre-defined number of vCPUs, hypervisors, compute hosts on a TEC element. Each of the vCPUs, hypervisors, and compute hosts may be programmed to operate at a maximum capacity to produce a maximum throughput value. The vCPU 1612 describes a portion or share of a physical CPU that is assigned to a VM for a specific application. The number of vCPUs 1621 describes a total amount of vCPUs of the TEC element reserved for the application, a number of vCPUs on the TEC element used by the application, and/or a number of available vCPUs of the TEC element permitted to be used by the application. The hypervisor 1615 describes a program that hosts and manages VMs and assigns the resources of a physical system to a specific VM for a specific application A status of the hypervisor (up or down) provides an idea of TEC's health on VM operation for a specific application. The compute host 1618 describes hosts VMs on which instances may be created by the hypervisor for a specific application. A number of VMs running instances out of a maximum number of VMs for a host, a number of VMS that are idle at a host, and/or a number of VMs that are capable of running an instance at a host may be used in determining resource capacity. The number of compute hosts 1627 describes a total amount of compute hosts of the TEC element reserved for the application, a number of compute hosts of the TEC element used by the application, and/or a number of available compute hosts of the TEC element permitted to be used by the application.

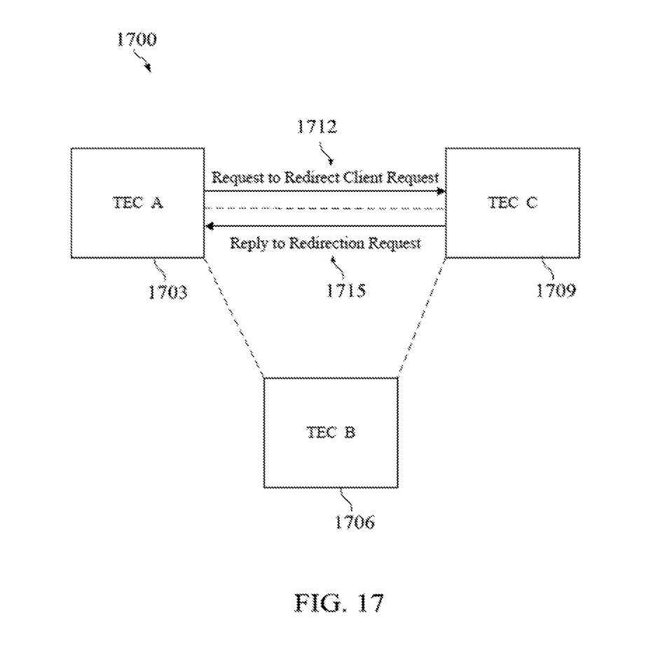

FIG. 17 is a schematic diagram of an embodiment of a federation 1700 in which client requests are redirected from one TEC element to another. The federation 1700 may be similar to the federation 207, 800, and 1200 of FIGS. 2, 8, and 12. The federation 1700 comprises TEC element A 1703, TEC element B 1706, and TEC element C 1709. Each of the TEC elements A-C 1703. 1706, and 1709 in federation 1700 may be similar to the TEC elements 206, 300, and 600 of FIGS. 2-6.

In an embodiment, each of the TEC elements A-C 1703, 1706, and 1709 are configured to store federation resource data in the federation resources 339 of FIG. 3. The federation resource data includes generic resource containers, such as the generic resource container 1403 of FIG. 14, and application specific resource containers, such as the application-specific resource container 1603 of FIG. 16, for each of the TEC elements in the federation. The TEC elements A-C 1703, 1706, and 1709 are each configured to receive requests from clients, such as clients 224 and 226 of FIG. 2, for data and/or services. In an embodiment, the TEC element A 1703 may be configured to serve clients of a first geographic area, the TEC element B 1706 may be configured to serve clients of a second geographic area, and TEC element C 1709 may be configured to serve clients of a third geographic area. The TEC elements A-C 1703, 1706, and 1709 may together form a federation 1700 in which each of the TEC elements A-C 1703, 1706, and 1709 share resources to provide clients the requested data and/or services. In an embodiment, TEC element A 1703 may receive a request from a client for Internet access. Suppose that TEC element A 1703 has insufficient resources to provide Internet access to the client. In such a case, the TEC element A 1703 would search the federation resource data in the memory device to see if any other TEC elements in the federation have sufficient resources to provide Internet access to the client. In some embodiments, multiple TEC elements in the federation may have sufficient resources to provide requested data and/or services to the client. In such a case, the TEC element A 1703 may select the TEC element in the federation that has the most resources available based on the resource containers stored in the memory device. As shown in FIG. 17, once the TEC element A 1703 selects the TEC element C 1709 as the device in the federation with sufficient resources to satisfy the request, the TEC element A 1703 sends a request to redirect the client request 1712 to TEC element C.

TEC element C may determine whether to accept or deny the redirection request 1715. For example, TEC element C 1709 may determine that there are still sufficient resources to satisfy the client request, and then send a reply to the redirection request 1715 indicating that TEC element C 1709 is accepting the redirection request. In such a case, the TEC element A 1703 may forward the request for Internet access from the client to TEC element C 1709. The TEC element C 1709 may then provide Internet access to the client without accessing the packet network (e.g., packet network 202 of FIG. 2). The client may receive Internet access from the TEC element C 1709 without knowing that the initial request was redirected in between TEC elements of a federation. In this way, the sharing of resources between TEC elements in the federation is transparent to the clients. In one embodiment, the TEC element C 1709 may send a reply to the redirection request 1715 indicating that the TEC element C 1709 denies the redirection request when, for example, the TEC element C 1709 no longer has sufficient resources to provide Internet access to the client.

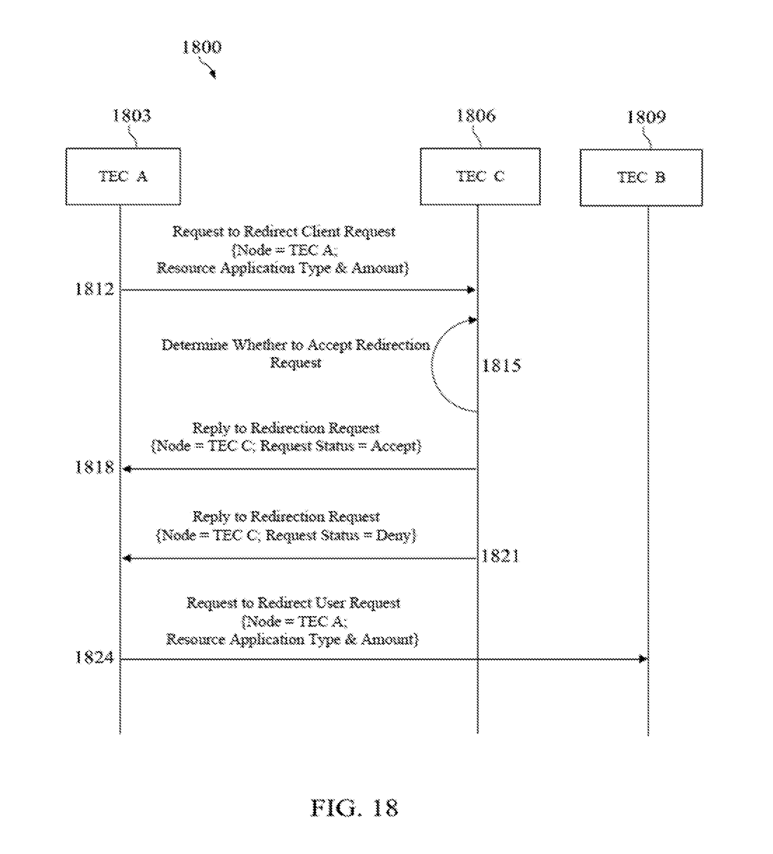

FIG. 18 is a message sequence diagram 1800 illustrating an embodiment of a TEC element A 1803 attempting to redirect the client request to TEC element C 1806 and TEC element B 109. TEC element A 1803, TEC element C 1806, and TEC element B 1809 may be part of the same federation. In an embodiment, the federation is similar to the federations 1200 and 1700 of FIGS. 12 and 17. The diagram 1800 illustrates messages exchanged by TEC element A 1803, TEC element C 1806, and TEC element B 1809 during requesting to redirect a client request to another TEC element in the federation. In such cases, the TEC elements are similar to TEC elements 206, 300, 400, 500, and 600 of FIGS. 2-6.

At step 1812, TEC element A 1803 sends a redirection request to redirect a client request to TEC element C 1806. For example, the inter-TEC federation manager 679 of TEC element A 1803 instructs the networking resources 623 and network I/O 632 of FIG. 6 to send the redirection request to TEC element C 1806. In one embodiment, the redirection request to redirect the client request may include an identifier of the requesting TEC element A 1803, a resource application type that is requested, and an amount of resources requested. The resource application type may be associated with any of the applications described with reference to the TEC application layer 605 of FIG. 6. The amount of resources may refer to any of the resources referred to with referenced to the generic resource container 1403 of FIG. 14 and the application-specific resource container 1603 of FIG. 16. At step 1815, TEC element C 1806 determines whether to accept the redirection request from TEC element A 1803. For example, the computing resources 620 of TEC element C 1806 determines whether TEC element C 1806 still has enough resources to satisfy the client request. In an embodiment, TEC element C 1806 determines whether the resources reserved for the specific application type included in the redirection request are still available at the TEC C element 1806. For example, TEC element 1806 determines whether the resources available at the TEC element C 1806 is greater than the amount included in the redirection request.

TEC element C 1806 sends a reply to the redirection request to the TEC element A 1803 based on the determination of whether to accept the redirection request. For example, the inter-TEC federation manager 679 of TEC element C 1806 instructs the networking resources 623 and network I/O 632 of FIG. 6 to send the reply to the redirection request to TEC element A 1803. In an embodiment, the reply to the redirection request includes an identifier of TEC element C 1806 that sends the reply to the redirection request and a status indicating whether TEC element C 1806 accepts or denies the request. At step 1818, TEC element C 1806 sends a reply to the redirection request indicating that TEC element C 1806 accepts the redirection request and will provide the requested data and/or services to the client. If, however, the TEC element C is unable to accept the redirection request, then TEC element C 1806 sends a reply to the redirection request indicating that TEC element C 1806 denies the redirection request at step 1821. In an embodiment, TEC element A 1803 selects TEC element B 1809 as another TEC element in the federation that has sufficient resources to satisfy the client request. At step 1824, TEC element A 1803 sends a request to redirect the client request to TEC element B 1809. For example, the inter-TEC federation manager 679 of TEC element A 1803 instructs the networking resources 623 and network I/O 632 of FIG. 6 to send the redirection request to TEC element B 1809. TEC element B 1809 determines whether the accept or deny the redirection request similar to the manner that TEC element C 1806 does in steps 1815, 1818, and 1821. In this way, TEC element A 1803 continues to send requests to TEC elements in the federation to redirect the client request until one of the TEC elements in the federation accepts the request. In an embodiment, TEC element A 1803 sends requests to the TEC elements in the federation according to a pre-defined rank that is an ordered list of TEC elements based on a total amount of resources of the TEC elements. The pre-defined rank may be stored at the federation policy 342 of FIG. 3.

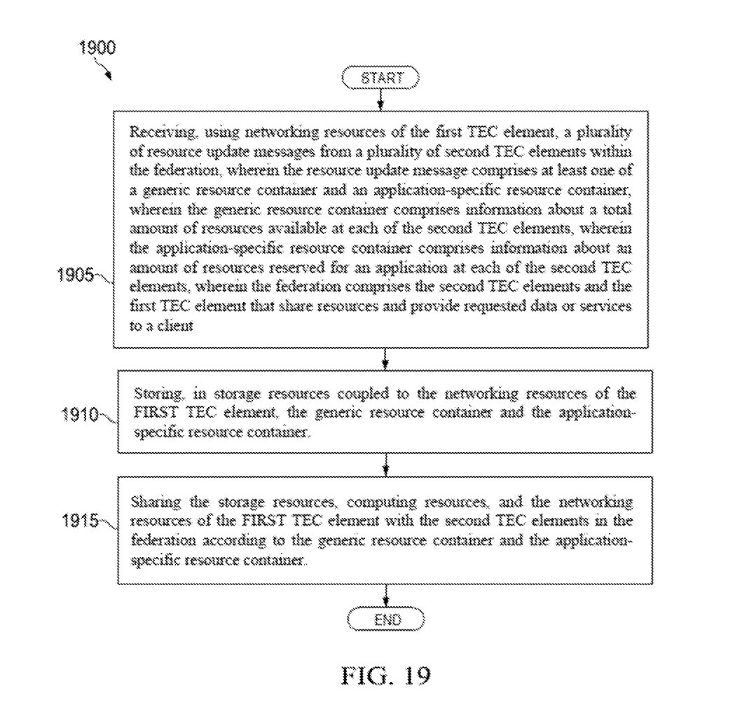

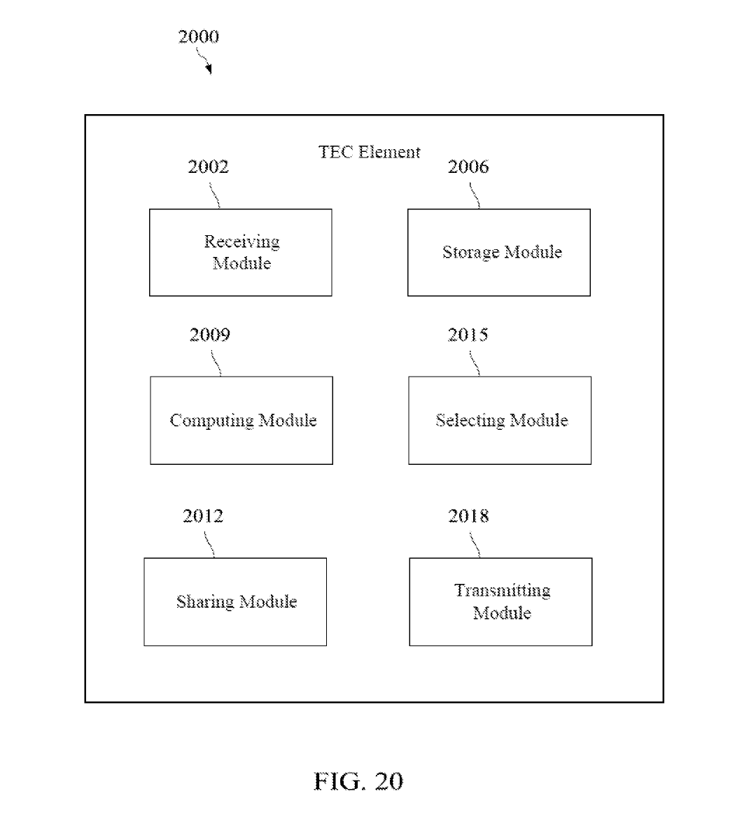

FIG. 19 is a flowchart of an embodiment of a method 1900 used by a TEC element to share resources with other TEC elements in a federation to provide requested data and services to the client. The method 1900 is implemented by one of the TEC elements in a federation deployed between a client and a packet network. In an embodiment, the method 1900 is implemented after a federation of TEC elements has been formed. In an embodiment, the TEC element is similar to the TEC elements 206, 300, 400, and 500 of FIGS. 2-5. In an embodiment, the federation is similar to the federations 207, 800, 1200, and 1700 of FIGS. 2, 8, 12, and 17. At block 1905, a plurality of resource update messages from a plurality of second TEC elements in a federation is received using networking resources of the TEC element. The resource update message comprises a generic resource container and an application-specific resource container. The generic resource container comprises information about a total amount of resources available to each of the second TEC elements, and the application-specific resource container comprises information about an amount of resources reserved for an application. The federation comprises the second TEC elements and the first TEC element that share resources and provide requested data or services to a client. For example, networking resources, such as networking resources 623 of FIG. 6 receives the resource update messages from the second TEC elements. At block 1910, the generic resource container and the application-specific resource container are stored in storage resource coupled to the networking resources of the TEC element. For example, the information in the resource update messages are stored in storage resources similar to the storage resources 628 of FIG. 6. At block 1915, the storage resources, computing resources, and the networking resources of the TEC element are shared with the second TEC elements in the federation according to the generic resource container and the application-specific resource container. For example, the networking resources, such as the networking resources 623 of FIG. 6, may receive requests from one of the second TEC elements in the federation to share at least one of the storage resources, networking resources, or computing resources of the first TEC element to satisfy a request from the client. The first TEC element may provide requested data and/or services to the client when the first TEC element has sufficient resources to satisfy the request.

FIG. 20 is a functional block diagram of a TEC element 2000 configured to share resources with other TEC elements in the federation to provide data and services to clients. In an embodiment, the TEC element 2000 may be similar to TEC elements 206, 300, 400, and 500 of FIGS. 2-5 and configured to implement method 2000. In an embodiment, the federation is similar to the federations 207, 800, 1200, and 1700 of FIGS. 2, 8, 12, and 17.

TEC element 2000 comprises a receiving module 2002, a storage module 2006, a computing module 2009, a sharing module 2012, a selecting module 2015, and transmitting module 2018. In an embodiment, the receiving module 2002, storage module 2006, computing module 2009, sharing module 2012, selecting module 2015, and transmitting module 2018 may be coupled together.

In an embodiment, the receiving module 2002 comprises a means for receiving resource update messages from second TEC elements within the federation. In an embodiment, the resource update message comprises at least one of a generic resource container and an application-specific resource container. The generic resource container comprises information about a total amount of resources available at each of the second TEC elements, and the application-specific resource container comprises information about an amount of resources reserved for an application at each of the second TEC elements. The federation comprises the second TEC elements and the TEC element 2000 that share resources and provide requested data or services to a client. The receiving module 2002 also comprises a means for receiving a request from a client for the data or the services provided by an application on an application layer of the first TEC element.

The storage module 2006 comprises a means for storing the generic resource container and the application-specific resource container. The computing module 2009 comprises a means for obtaining the information about the total amount of resources available at each of the second TEC elements from the generic resource container and a means for obtaining information about the amount of resources reserved for the application at each of the second TEC elements from the application-specific resource container. The sharing module 2012 comprises a means for sharing the receiving module 2002, the storage module 2006, the computing module 2009, the selecting module 2015, and the transmitting module 2018 of the TEC element 2000 with the second TEC elements in the federation according to the generic resource container and the application-specific resource container.

The selecting module 2015 comprises a means for selecting one of the second TEC elements when the storage resources indicates that the one of the second TEC elements has sufficient resources to accommodate the request from the client. In an embodiment, the computing module 2009 may also comprise a means for selecting one of the second TEC elements when the storage resources indicates that the one of the second TEC elements has sufficient resources to accommodate the request from the client . The transmitting module 2018 comprises a means for transmitting a redirection request to redirect the request from the client to the selected one of the TEC elements. The transmitting module 2018 also comprises a means for transmitting the request from the client to the selected one of the TEC elements in response to receiving an acceptance of the redirection from the selected one of the TEC elements. In an embodiment, the TEC element 2000 is deployed between the client and a packet network

In an embodiment, the disclosure includes a first TEC element within a federation, comprising a means for transmitting a first general update message to a plurality of second TEC elements within the federation, wherein the first general update message comprises a first generic resource container of the first TEC element, wherein the first generic resource container identifies a total amount of resource capacity of the first TEC element, and wherein the federation containing the second TEC elements and the first TEC element share resources to provide at least one of data and services to a requesting client, a means for transmitting a first application-specific update message to the second TEC elements within the federation, wherein the first application-specific update message comprises a first application-specific resource container of the first TEC element, and wherein the first application-specific resource container identifies an amount of resources reserved by the first TEC element for an application, a means for receiving a plurality of second resource update messages from the second TEC elements within the federation, wherein each of the second resource update messages comprise a second generic resource container and a second application-specific resource container, wherein the second generic resource container identifies a total amount of resource capacity of each of the second TEC elements, and wherein the second application-specific resource container identifies an amount of resources reserved by the each of the second TEC elements for the application, and a means for storing the second generic resource container and the second application-specific resource container for each of the second TEC elements, wherein the first TEC element and the second TEC elements are deployed between the client and a packet network.

In an embodiment, the disclosure includes a means for transmitting a first general update message to a plurality of second TEC elements that within a federation, wherein the first general update message comprises a first generic resource container of the apparatus, wherein the first generic resource container identifies a total amount of resource capacity of the apparatus, and wherein the federation containing the second TEC elements and the apparatus share resources to provide at least one of data and services to a requesting client, a means for transmitting a first application-specific update message to the second TEC elements within the federation, wherein the first application-specific update message comprises a first application-specific resource container of the apparatus, and wherein the first application-specific resource container identifies an amount of resources reserved by the first TEC for an application, a means for receiving a plurality of second update messages from the second TEC elements within the federation, wherein each of the second update messages comprise at least one of a second generic resource container and a second application-specific resource container, wherein the second generic resource container identifies a total amount of resource capacity of each of the second TEC elements, and wherein the second application-specific resource container identifies an amount of resources reserved by the each of the second TEC elements for the application, and a means for storing the second generic resource container and the second application-specific resource container for each of the second TEC elements, wherein the first TEC element and the second TEC elements are deployed between the client and a packet network.

As shown in FIG. 20, the disclosure includes a means for receiving, using networking resources of the first TEC element, a plurality of resource update messages from a plurality of second TEC elements within the federation, wherein the resource update message comprises at least one of a generic resource container and an application-specific resource container, wherein the generic resource container comprises information about a total amount of resources available at each of the second TEC elements, wherein the application-specific resource container comprises information about an amount of resources reserved for an application at each of the second TEC elements, wherein the federation comprises the second TEC elements and the first TEC element that share resources and provide requested data or services to a client, a means for storing, in storage resources coupled to the networking resources of the first TEC element, the generic resource container and the application-specific resource container, and a means for sharing the storage resources, computing resources, and the networking resources of the first TEC element with the second TEC elements in the federation according to the generic resource container and the application-specific resource container, wherein the first TEC element and the second TEC elements are deployed between the client and a packet network.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

W hat is claimed is:

1. A first telecommunications edge cloud (TEC) element within a federation, comprising:
computing resources comprising a plurality of processors;
networking resources coupled to the computing resources and comprising a plurality of network input and output ports, wherein the networking resources are configured to:
transmit a first general update message to a plurality of second TEC elements within the federation, wherein the first general update message comprises a first generic resource container of the first TEC element, wherein the first generic resource container identifies a total amount of resource capacity of the first TEC element, and wherein the federation containing the second TEC elements and the first TEC element share resources to provide at least one of data and services to a requesting client;
transmit a first application-specific update message to the second TEC elements within the federation, wherein the first application-specific update message comprises a first application-specific resource container of the first TEC element, and wherein the first application-specific resource container identifies an amount of resources reserved by the first TEC element for an application; and
receive a plurality of second resource update messages from the second TEC elements within the federation, wherein each of the second resource update messages comprise a second generic resource container and a second application-specific resource container, wherein the second generic resource container identifies a total amount of resource capacity of each of the second TEC elements, and wherein the second application-specific resource container identifies an amount of resources reserved by the each of the second TEC elements for the application; and
storage resources coupled to the computing resources and the networking resources and configured to store the second generic resource container and the second application-specific resource container for each of the second TEC elements,
wherein the first TEC element and the second TEC elements are deployed between the client and a packet network.

2. The first TEC element of claim 1, wherein the networking resources are further configured to receive a federation creation request from a second TEC element, wherein the second TEC element is the master TEC element in the federation and is the only TEC element in the federation that is permitted to add new TEC elements to the federation and remove TEC elements from the federation.

3. The first TEC element of claim 2, wherein the networking resources are further configured to receive a master assignment request from the second TEC element, wherein the master assignment request is a request for the first TEC element to assume the role of the master TEC element in the federation.

4. The first TEC element of claim 1, wherein the first TEC element sends a federation creation request to a second TEC element, wherein the first TEC element is the only TEC element in the federation that is permitted to add new TEC elements to the federation and remove TEC elements from the federation.

5. The first TEC element of claim 1, wherein the first TEC element comprises an application layer, a TEC operating system (TECOS), and a hardware layer, wherein the hardware layer comprises the computing resources, the networking resources, and the storage resources, wherein the TECOS comprises an inter-TEC federation manager configured to manage communication and sharing resources with the second TEC elements of the federation, and wherein the application layer comprises an application that receives a request from the requesting client for the data or the services.

6. The first TEC element of claim 1, wherein the networking resources further comprises at least one of a provider edge (PE) router, an optical line terminal (OLT), a broadband network gateway (BNG), wireless access point equipment, and an optical transport network (OTN) switch.

7. The first TEC element of claim 1, further comprising an application layer configured to receive a request from the requesting client for the data or the services corresponding to an application on the application layer, wherein the computing resources are configured to select one of the second TEC elements in the federation that has sufficient resource capacity to provide the data or services to the client according to at least one of the second generic resource container and the second application-specific resource container for each of the second TEC elements, and wherein the networking resources are configured to redirect the request to the selected one of the second TEC elements in the federation.

8. An apparatus for providing cloud computing services to a client, comprising:
computing resources comprising a plurality of processors;
networking resources coupled to the computing resources and comprising a plurality of network input and output ports, wherein the networking resources are configured to:
transmit a first general update message to a plurality of second TEC elements that within a federation, wherein the first general update message comprises a first generic resource container of the apparatus, wherein the first generic resource container identifies a total amount of resource capacity of the apparatus, and wherein the federation containing the second TEC elements and the apparatus share resources to provide at least one of data and services to a requesting client;
transmit a first application-specific update message to the second TEC elements within the federation, wherein the first application-specific update message comprises a first application-specific resource container of the apparatus, and wherein the first application-specific resource container identifies an amount of resources reserved by the first TEC for an application;
receive a plurality of second update messages from the second TEC elements within the federation, wherein each of the second update messages comprise at least one of a second generic resource container and a second application-specific resource container, wherein the second generic resource container identifies a total amount of resource capacity of each of the second TEC elements, and wherein the second application-specific resource container identifies an amount of resources reserved by the each of the second TEC elements for the application; and
storage resources coupled to the computing resources and the networking resources and configured to store the second generic resource container and the second application-specific resource container for each of the second TEC elements,
wherein the first TEC element and the second TEC elements are deployed between the client and a packet network.

9. The apparatus of claim 8, wherein the first general update message comprises an identifier of the apparatus, an identifier of the federation, and a resource container, wherein the resource container comprises at least one of a server load, a power consumption, a virtual central processing unit (vCPU) load, a hypervisor capacity, a computing hosts capacity, a number of vCPUs available for execution, a status of a hypervisor, a number of computing hosts available for execution, a number of virtual machines (VMs) that are capable of running an instance for each host, a number of VMs that are running instances for each host, and a number of VMs that are idle.

10. The apparatus of claim 8, wherein the first application-specific update message comprises an identifier of the apparatus, an identifier of the federation, an identifier of the application, and an application-specific resource container, wherein the application specific resource container comprises at least one of a server load assigned to the application, a power consumption assigned to the application, a virtual central processing unit (vCPU) load assigned to the application, a hypervisor capacity assigned to the application, a computing hosts capacity assigned to the application, a number of vCPUs available for execution assigned to the application, a status of a hypervisor for the application, a number of computing hosts available for execution assigned to the application, a number of virtual machines (VMs) that are capable of running an instance for each host assigned to the application, a number of VMs that are running instances for each host assigned to the application, and a number of VMs that are idle assigned to the application.

11. The apparatus of claim 8, further comprising an application layer configured to receive a request from the requesting client for the data or the services corresponding to an application on the application layer, wherein the computing resources are configured to select one of the second TEC elements in the federation that has sufficient resource capacity to provide the data or the services to the client, and wherein the networking resources are configured to:
transmit a redirection request to redirect the request from the client to the selected one of the second TEC elements in the federation;
receive an acceptance of the redirection request from the selected one of the second TEC elements in the federation; and
redirect the request from the client to the selected on of the second TEC elements in the federation.

12. The apparatus of claim 8, further comprising comprises an application layer, a TEC operating system (TECOS), and a hardware layer, wherein the hardware layer comprises the computing resources, the networking resources, and the storage resources, wherein the TECOS comprises an inter-TEC federation manager configured to manage communication and sharing resources with the second TEC elements of the federation, and wherein the application layer comprises an application that receives a request from the requesting client for data or a service.

13. A method implemented by a first telecommunications edge cloud (TEC) element within a federation, comprising:
receiving, using networking resources of the first TEC element, a plurality of resource update messages from a plurality of second TEC elements within the federation, wherein the resource update message comprises at least one of a generic resource container and an application-specific resource container, wherein the generic resource container comprises information about a total amount of resources available at each of the second TEC elements, wherein the application-specific resource container comprises information about an amount of resources reserved for an application at each of the second TEC elements, wherein the federation comprises the second TEC elements and the first TEC element that share resources and provide requested data or services to a client;
storing, in storage resources coupled to the networking resources of the first TEC element, the generic resource container and the application-specific resource container; and
sharing the storage resources, computing resources, and the networking resources of the first TEC element with the second TEC elements in the federation according to the generic resource container and the application-specific resource container,
wherein the first TEC element and the second TEC elements are deployed between the client and a packet network.

14. The method implemented by the TEC element of claim 13, wherein the storage resources are further configured to store a federation policy identifying with the federation, wherein the federation policy comprises a rank of the second TEC elements in the federation according to a resource capacity of each of the second TEC elements.

15. The method implemented by the TEC element of claim 13, wherein the resource update messages are received from the second TEC elements of the federation periodically according to a pre-defined schedule stored in the storage resources.

16. The method implemented by the TEC element of claim 13, wherein the resource update messages only comprise the application-specific resource container, wherein the application-specific resource container only comprises information about a single resource that has exceeded a threshold indicating that the single resource is unavailable to be shared.

17. The method implemented by the TEC element of claim 16, wherein the resource update message including the application-specific resource container only comprises information about the single resource.

18. The method implemented by the TEC element of claim 13, wherein sharing the storage resources, the computing resources, and the networking resources of the TEC element with the second TEC elements in the federation further comprises:
receiving a request from the client for the data or the services provided by an application on an application layer of the first TEC element; and
selecting, using the computing resources, one of the second TEC elements when the storage resources indicates that the one of the second TEC elements has sufficient resources to accommodate the request from the client.

19. The method implemented by the first TEC element of claim 18, wherein sharing the storage resources, computing resources, and the networking resources of the TEC element with the second TEC elements in the federation further comprises:
transmitting, using the networking resources, a redirection request to redirect the request from the client to the selected one of the TEC elements; and
transmitting, using the networking resources, the request from the client to the selected one of the TEC elements in response to receiving an acceptance of the redirection from the selected one of the TEC elements.

20. The method implemented by the TEC element of claim 13, wherein the first TEC element is a master TEC element of the first TEC element, and wherein the first TEC element is the only TEC element in the federation permitted to request additional TEC elements to join the federation.
